(19) United States
(12) Patent Application Publication
(10) Pub. No.: US 2006/0038741 A1
(43) Pub. Date: Feb. 23, 2006

(54) System and method for implementing a multi-monitor interface for a data processing system

(75) Inventors: Hidetoshi Mori, Yamato-Shi (JP); Tomoaki Kondo, Ayase-Shi (JP)

Correspondence Address: DILLION & YUDELL, LLP, 8911 N CAPITAL OF TEXAS HWY, SUITE 2110, AUSTIN, TX, 78759, US

(73) Assignee: International Business Machines Corporation, Armonk, NY (US)

(21) Appl. No.: 11/202,755

(22) Filed: Aug. 12, 2005

(30) Foreign Application Priority Data
Aug. 23, 2004 (JP) JP2004-242381

(51) Int. Cl. G09G 5/00

(52) U.S. Cl. 345/1.1

(57) ABSTRACT

To provide a multi-monitor system capable of enhancing operability of a mouse in an extended desktop environment. When a screen M1 of a primary monitor 11 is connected to a screen M2 of a secondary monitor 21 in a shifted manner at a predetermined section B2-D1, mark windows 50 are displayed on the screen M1 of the primary monitor 11 and the screen M2 of the secondary monitor 21 adjacently to the predetermined section B2-D1 in order to accurately and promptly grasp the predetermined position B2-D1 where a mouse pointer MP is movable. As options, the mark window 50 is hidden when the mouse pointer MP is moved onto the mark window 50 or in the vicinity thereof, the mouse pointer MP is temporarily stopped at the predetermined section, and a number of a destination monitor is displayed on the original screen when the mouse pointer MP is moved to the other screen.

### PRIORITY CLAIM

This application claims priority of Japanese Patent Application No. JP2004-242381, filed on Aug. 23, 2004, and entitled, “Multi-Monitor System, Multi-Monitor Method and Mark Displaying Program Product.”

### BACKGROUND OF THE INVENTION

1. Technical Field

The present invention relates in general to the field of data processing systems. More particularly, the present invention relates to the field of data processing system interfaces. Still more particularly, the present invention relates to a system and method of implementing a multi-monitor interface for a data processing system.

2. Description of the Prior Art

The present invention relates to a multi-monitor system, a multi-monitor method, and a mark displaying program product. More specifically, the present invention relates to a multi-monitor system, a multi-monitor method, and a mark displaying program product to be operated in an extended desktop environment in which screens of two or more monitors (displays) are virtually connected and a pointer displayed in compliance with a pointing device is bi-directionally movable between the screens.

An extended desktop environment has a function called “multi-monitor (or multi-display)” in which two or more monitors are connected to one computer so that the monitors are used as one large monitor. Here, description will be made on the case where two monitors (hereinafter one of the monitors will be referred to as a “primary monitor” and the other monitor a “secondary monitor”) are connected to one computer and a right edge of a screen of the primary monitor is virtually connected to a left edge of the secondary monitor.

For example, as shown in FIG. 30, when resolutions of the both monitors are the same and upper ends and lower ends of screens M1 and M2 are precisely matched, it is possible to move a mouse pointer (a cursor) MP freely between the both screens M1 and M2.

However, as shown in FIG. 31, if the screen M2 of the secondary monitor is virtually shifted from the screen M1 of the primary monitor in the vertical direction, a movable section of the mouse pointer MP between the both screens M1 and M2 is restricted to a section B-C. For example, when moving the mouse pointer MP on the screen M1 of the primary monitor in the right direction toward the section B-C, it is possible to move the mouse pointer MP directly beyond the section B-C and onto the screen M2 of the secondary monitor. However, when moving the mouse pointer MP on the screen M1 of the primary monitor in the right direction toward a section C-D, the mouse pointer MP is stopped on the section C-D and it is not possible to move the mouse pointer MP onto the screen M2 of the secondary monitor. By contrast, when moving the mouse pointer MP on the screen M2 of the secondary monitor in the left direction toward a section A-B, the mouse pointer MP is stopped on the section A-B and it is not possible to move the mouse pointer MP onto the screen M1 of the primary monitor.

Meanwhile, as shown in FIG. 32, when the resolutions of the both monitors are different and it is not possible to match the upper ends and the lower ends of the screens M1 and M2 precisely, the move-allowing section of the mouse pointer MP between the both screens M1 and M2 is restricted to the section B-C as in the foregoing case.

Although the foregoing examples describe the cases of arranging the both screens M1 and M2 horizontally, with M1 on the right side and M2 on the left side, the movable section of the mouse pointer MP between the both screens M1 and M2 is restricted as in the foregoing cases when the both screens M1 and M2 are arranged vertically. As a result, the following problems arise.

First, when the move-allowing section of the mouse pointer MP between the both screens M1 and M2 is limited, a user has to grope for the move-allowing section B-C. In FIG. 31 and FIG. 32, it is possible to identify the move-allowing section B-C because the virtual positional relation between the both screens M1 and M2 is illustrated. However, in reality, the physical positional relation between the both screens M1 and M2 does not always coincide with the virtual positional relation, hence it is not possible to identify the move-allowing section B-C.

Second, when the user operates the mouse pointer MP in the vicinity of the move-allowing section B-C of the mouse pointer MP, the user may move the mouse pointer MP unintentionally onto the other screen. In this case, the user often tries to find the mouse pointer MP by moving a pointing device such as a mouse in various directions while watching the original screen. However, when the move-allowing section of the mouse pointer MP is limited, the mouse pointer MP once moved does not come back to the original screen soon, and it may take quite a long time to discover the mouse pointer MP.

For example, when the mouse pointer MP is unintentionally moved from the screen M1 of the primary monitor to the screen M2 of the secondary monitor shown in FIG. 31, the mouse pointer MP may be hindered by the move-restricting section A-B if the mouse pointer MP is moved to an upper part of the screen M2 and it may be difficult to place the mouse pointer MP back to the screen M1 of the primary monitor.

When the mouse pointer MP is lost, it is possible to find the mouse pointer MP by looking at the other screen immediately. However, the both monitors are often disposed physically away from each other. Accordingly, there is a long moving distance of a sight line between the both monitors, and immediately after the mouse pointer MP is lost, attention of the user is usually focused on the original screen that the user was working on. For this reason, the mouse pointer MP on the other screen will not be in sight of the user and the user may need to spend quite a long time for finding the mouse pointer MP as a consequence.

Japanese Patent Unexamined Published Application No. 5-143238 (Patent Document 1) discloses a pointing cursor controlling device for a multi-window system capable of displaying two or more windows on one screen, which is configured to move a cursor on a screen by use of a pointing device. This device is configured to stop a cursor temporarily when the cursor reaches a boundary of a window, and to move the cursor out of the window when a user moves the pointing device at a predetermined distance or greater, or at a predetermined speed or faster. This publication is merely a disclosure of a method of moving a cursor between windows in a multi-window system, and does not disclose a method of moving a cursor between screens in a multi-monitor system.

Japanese Patent Unexamined Published Application No. 2002-323968 (Patent Document 2) discloses a multi-computer system for connecting two or more computers to one monitor. This system is configured to display two or more computer designated regions on a screen of the monitor while relating the computer designated regions to the two or more connected computers respectively, and to allow a user to switch to the computer related to the computer designated region by moving a cursor to the desired computer designated region. This publication is merely a disclosure of a multi-computer system, and does not disclose a multi-monitor system for connecting two or more monitors to one computer.

Japanese Patent Unexamined Published Application No. 5-27941 (Patent Document 3) discloses a display system capable of switching between scrolling and moving a pointer. This system is configured to provide a window frame displayed on the screen with a region (a window scroll area) which allows passage of a pointer and a region which does not allow passage of the pointer, to scroll a display inside the window when a user attempts to move the pointer through the window scroll area and to the outside of the window, and to allow the user to move the pointer freely in the region which does not allow passage of the pointer. This publication merely discloses a scrolling method by use of a mouse, and does not disclose a method of moving a pointer in a multi-monitor system.

### SUMMARY OF THE INVENTION

An object of the present invention is to provide a multi-monitor system, a multi-monitor method, and a mark displaying program product for an extended desktop environment where screens of two or more monitors are virtually connected and a pointer displayed in compliance with a pointing device is bi-directionally movable between screens, which are capable of enhancing operability of a pointing device.

Another object of the present invention is to provide a multi-monitor system, a multi-monitor method, and a mark displaying program product, which are capable of identifying a position where a pointer is bi-directionally movable between screens.

Still another object of the present invention is to provide a multi-monitor system, a multi-monitor method, and a mark displaying program product, which are capable of indicating movement of a pointer from a screen to another screen.

An aspect of a multi-monitor system according to the present invention includes a first monitor and a second monitor, a pointing device for instructing coordinates of a pointer to be displayed on screens of the first and second monitors, pointer display controlling means for displaying the pointer at the coordinates instructed by the pointing device, extended desktop setting means for virtually connecting a periphery of the screen of the first monitor to a periphery of the screen of the second monitor in a predetermined position and rendering the pointer bi-directionally movable between the screens of the first and second monitors, and means for displaying an object for identifying the predetermined position at least on one screen of the first and second monitors. The pointing device may be a mouse, an in-keyboard pointing device or a track ball, for example. Although at least two monitors are necessary herein, it is possible to provide three or more monitors. The extended desktop setting means connects the screens at a predetermined linear section as the predetermined position when connecting the screens horizontally or vertically, and connects the screens at a vertex as the predetermined position when connecting the screens obliquely. Designs including a figure such as an icon, a symbol, a character, wallpaper, and the like are used as the object, for example.

In this system, the object for identifying the predetermined position is displayed at least on one screen of the first and second monitors. Accordingly, it is possible to identify the position where the pointer is bi-directionally movable between the screens. As a result, it is easy to move the pointer bi-directionally between the both screens without losing sight of the pointer, for example. In this way, it is possible to enhance operability of the pointing device.

Preferably, the object is a mark window to be displayed adjacently to the predetermined position.

In this case, since the mark window has a predetermined area, it is even easier to identify the predetermined position.

Preferably, the multi-monitor system further includes means for stopping display of the mark window which is activated when the pointer is moved onto the mark window or in the vicinity thereof.

In this case, the mark window is concealed when the pointer is moved onto the mark window or in the vicinity thereof. Accordingly, it is also possible to operate an object (such as an icon, a task bar, a tool bar, or another window) hidden behind the mark window. In this way, the mark window does not bother other operations.

Preferably, the multi-monitor system further includes means for forcibly stopping the pointer when the pointer reaches the predetermined position, and pointer movement permitting means for releasing the stop of the pointer and permitting movement of the pointer to the other screen when the pointing device instructs coordinates for moving the pointer from one of the screens to the other screen of the first and second monitors after the pointer is forcibly stopped.

In this case, the pointer is forcibly stopped when the pointer reaches the predetermined position. Thereafter, the pointer is moved to the other screen when a user tries to move the pointer from one of the screens to the other screen. Accordingly, the user will not move the pointer to the other screen unintentionally.

More preferably, the multi-monitor system further includes means for detecting a stop of the pointing device after the pointer is forcibly stopped. The pointer movement permitting means performs the above-mentioned operation after the stop of the pointing device is detected.

In this case, after the pointer is forcibly stopped, the pointer is moved to the other screen when the user stops the pointing device temporarily and then tries to move the pointer from one of the screens to the other screen by moving the pointing device again. Accordingly, the pointer will not be moved to the other screen unless the user temporarily stops the pointing device intentionally.

Preferably, the multi-monitor system further includes means for displaying information on one of the screens for identifying the other screen when the pointer has been moved from one of the screens of the first and second monitors to the other screen.

In this case, when the pointer has been moved from one of the screens to the other screen, the information for identifying the other monitor is displayed on the screen of one of the monitors. Accordingly, the user can recognize movement of the pointer to the other screen on the screen of one of the monitors.

Preferably, the extended desktop setting means virtually connects one edge of the screen of the first monitor to a corresponding edge of the screen of the second monitor at a predetermined section as the predetermined position. The multi-monitor system further includes means for forcibly stopping the pointer when the pointer reaches a section on the edge other than the predetermined section, and pointer movement permitting means for allowing the pointer to skip to one of both ends of the predetermined section closer to a position of the pointer when the pointing device instructs the coordinates for moving the pointer from one of the screens of the first and second monitors to outside after the pointer is forcibly stopped, releasing the stop of the pointer, and permitting movement of the pointer to the other screen.

In this case, when the pointer reaches the section on the edge other than the predetermined section, the pointer is allowed to skip to one of the both ends of the predetermined section closer to the position of the pointer, and is moved to the other screen. Accordingly, it is possible to move the pointer in the section other than the predetermined section. Moreover, the pointer is forcibly stopped when the pointer reaches the section other than the predetermined section, and the pointer is moved to the other screen when the user further tries to move the pointer from one of the screens to the outside. In this way, the user will not move the pointer to the other screen unintentionally.

More preferably, the multi-monitor system further includes means for detecting a stop of the pointing device after the pointer is forcibly stopped. The pointer movement permitting means performs the above-mentioned operation after the stop of the pointing device is detected.

In this case, after the pointer is forcibly stopped, the pointer is moved to the other screen when the user stops the pointing device temporarily and then tries to move the pointer from one of the screens to the outside by moving the pointing device again. Accordingly, the pointer will not be moved to the other screen unless the user temporarily stops the pointing device intentionally.

Another aspect of a multi-monitor system according to the present invention includes a first monitor and a second monitor, a pointing device for instructing coordinates of a pointer to be displayed on screens of the first and second monitors, pointer display controlling means for displaying the pointer at the coordinates instructed by the pointing device, extended desktop setting means for virtually connecting a periphery of the screen of the first monitor to a periphery of the screen of the second monitor in a predetermined position and rendering the pointer bi-directionally movable between the screens of the first and second monitors, and means for displaying information on one of the screens for identifying the other screen when the pointer is moved from one of the screens of the first and second monitors to the other screen.

In this system, the information for identifying the other monitor is displayed on the screen of one of the monitors when the pointer is moved from one of the screens to the other screen. Accordingly, the user can recognize movement of the pointer to the other screen on the screen of one of the monitors.

An aspect of a mark displaying program product according to the present invention is a program product to be operated in an extended desktop environment where a periphery of a screen of a first monitor is virtually connected to a periphery of a screen of a second monitor in a predetermined position and a pointer displayed in compliance with a pointing device is rendered bi-directionally movable between the screens of the first and second monitors. Here, the program causes a computer to execute the steps of specifying the predetermined position, and displaying an object for identifying the specified predetermined position at least on one screen of first and second monitors.

According to this program product, the object for identifying the predetermined position is displayed at least on one screen of the first and second monitors. Accordingly, it is possible to identify the position where the pointer is bi-directionally movable between the both screens. As a result, it is easy to move the pointer bi-directionally between the both screens without losing sight of the pointer, for example. In this way, it is possible to enhance operability of the pointing device.

Another aspect of a mark displaying program product according to the present invention is a program product to be operated in an extended desktop environment where a periphery of a screen of a first monitor is virtually connected to a periphery of a screen of a second monitor in a predetermined position and a pointer displayed in compliance with a pointing device is rendered bi-directionally movable between the screens of the first and second monitors. Here, the program product causes a computer to execute the steps of detecting movement of the pointer from one of the screens to the other screen of the first and second monitors, and displaying information on the screen of one of the monitors for identifying the other monitor.

According to this program, the information for identifying the other monitor is displayed on the screen of one of the monitors when the pointer is moved from one of the screens to the other screen. Accordingly, the user can recognize movement of the pointer to the other screen on the screen of one of the monitors.

Meanwhile, a multi-monitor method according to the present invention is an operating method for using the multi-monitor system. Moreover, a recording medium according to the present invention is a computer-readable recording medium recording the above-described mark displaying program.

The above-mentioned features, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 illustrates a front view of an external configuration of an exemplary multi-monitor system according to a preferred embodiment of the present invention;

FIG. 2 is a functional block diagram depicting a configuration of a notebook personal computer shown in FIG. 1;

FIG. 3 is a functional block diagram illustrating programs stored in a hard disk shown in FIG. 2;

FIG. 4 is a functional block diagram depicting an internal configuration of the multi-monitor system shown in FIG. 1;

FIG. 5 is a flowchart illustrating an operation of the multi-monitor system shown in FIG. 1 to FIG. 4;

FIG. 6 depicts an extended desktop in which a screen of a primary monitor and a screen of a secondary monitor are horizontally connected to each other by use of an extended desktop function shown in FIG. 3 to FIG. 5;

FIG. 7 depicts an extended desktop in which the screen of the primary monitor and the screen of the secondary monitor are vertically connected to each other by use of the extended desktop function shown in FIG. 3 to FIG. 5;

FIG. 8 illustrates an extended desktop in which the screen of the primary monitor and the screen of the secondary monitor are obliquely connected to each other by use of the extended desktop function shown in FIG. 3 to FIG. 5;

FIG. 9 depicts an extended desktop in which the screen of the primary monitor and the screen of the secondary monitor having different resolutions are horizontally connected to each other by use of the extended desktop function shown in FIG. 3 to FIG. 5;

FIG. 10 is a flowchart illustrating mark window generation processing shown in FIG. 5;

FIG. 11 is a flowchart depicting details of processing for finding a layout of the monitors in the mark window generation processing shown in FIG. 10;

FIG. 12 is a flowchart illustrating details of processing for locating a predetermined section in the mark window generation processing shown in FIG. 10;

FIG. 13 depicts an extended desktop in which the screen of the primary monitor having a high resolution is located on a left side while the screen of the secondary monitor having a low resolution is located on a right side in the predetermined section specifying processing shown in FIG. 12;

FIG. 14 illustrates an extended desktop in which the screen of the primary monitor having a low resolution is located on the left side while the screen of the secondary monitor having a high resolution is located on the right side regarding the predetermined section specifying processing shown in FIG. 12;

FIG. 15 depicts an extended desktop in which the screen of the primary monitor is located on an upper left side while the screen of the secondary monitor is located on a lower right side regarding the predetermined section specifying processing shown in FIG. 12;

FIG. 16 illustrates an extended desktop in which the screen of the primary monitor is located on a lower left side while the screen of the secondary monitor is located on an upper right side regarding the predetermined section specifying processing shown in FIG. 12;

FIG. 17 is a flowchart depicting mark window property changing processing shown in FIG. 5;

FIG. 18 is a flowchart illustrating mouse pointer inter-screen movement control processing shown in FIG. 5;

FIG. 19 is a flowchart depicting a pointer temporary stop option in the mouse pointer inter-screen movement control processing shown in FIG. 18;

FIG. 20 is a flowchart illustrating processing when a timer is started in the pointer temporary stop option shown in FIG. 19;

FIG. 21 is a flowchart depicting a monitor number display option in the mouse pointer inter-screen movement control processing shown in FIG. 18;

FIG. 22 illustrates a display area for a monitor number to be displayed when a mouse pointer is moved from the screen of the primary monitor on the left side onto the screen of the secondary monitor on the right side in the monitor number display option shown in FIG. 21;

FIG. 23 depicts the display area for the monitor number to be displayed when the mouse pointer is moved from the screen of the primary monitor on the right side onto the screen of the secondary monitor on the left side in the monitor number display option shown in FIG. 21;

FIG. 24 illustrates the display area for the monitor number to be displayed when the mouse pointer is moved from the screen of the primary monitor on an upper side onto the screen of the secondary monitor on a lower side in the monitor number display option shown in FIG. 21;

FIG. 25 depicts the display area for the monitor number to be displayed when the mouse pointer is moved from the screen of the primary monitor on the lower side onto the screen of the secondary monitor on the upper side in the monitor number display option shown in FIG. 21;

FIG. 26 is a flowchart illustrating processing when a timer is started in the monitor number display option shown in FIG. 21;

FIG. 27 is a flowchart depicting a pointer skip option in the mouse pointer inter-screen movement control processing shown in FIG. 18;

FIG. 28 is a flowchart illustrating processing when a timer is started in the pointer skip option shown in FIG. 28;

FIG. 29 depicts an extended desktop in which arrows are displayed as objects for identifying a predetermined position instead of mark windows shown in FIG. 6;

FIG. 30 illustrates an extended desktop in which a right edge of a screen of a primary monitor is connected to a left edge of a screen of a secondary monitor;

FIG. 31 depicts an extended desktop in which the screen of the primary monitor shown in FIG. 30 shifts downward while the screen of the secondary monitor shifts upward; and

FIG. 32 illustrates an extended desktop in which a right edge of a screen of a high-resolution primary monitor is connected to a left edge of a screen of a low-resolution secondary monitor.

### DETAILED DESCRIPTION OF A PREFERRED EMBODIMENT

Now, an embodiment of the present invention will be described in detail with reference to the accompanying drawings. In the drawings, identical or similar constituents are designated by identical reference numerals, and repetitive explanation will be omitted.

1. Configuration

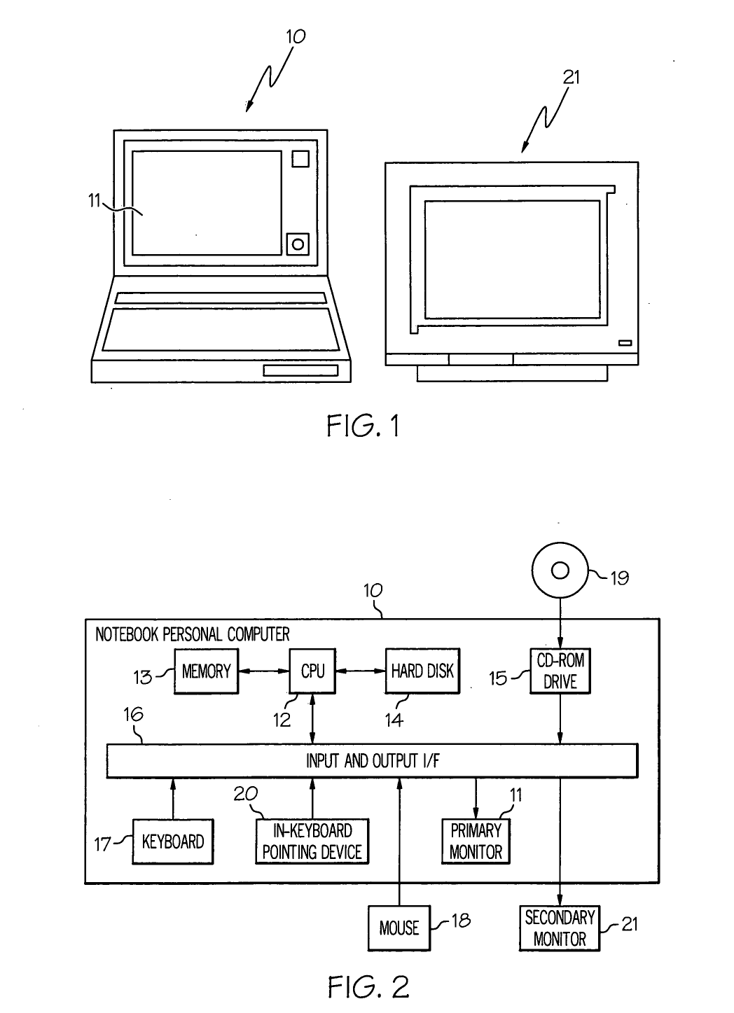

Referring to FIG. 1, a multi-monitor system 1 according to an embodiment of the present invention includes a notebook personal computer 10 and an external monitor 21. In this embodiment, a monitor 11 of the notebook personal computer 10 functions as a primary monitor and the external monitor 21 functions as a secondary monitor.

Referring to FIG. 2, the notebook personal computer 10 includes a central processing unit (CPU) 12, a memory 13, a hard disk 14, a compact disk-read only memory (CD-ROM) drive 15, and an input and output interface 16. A keyboard 17, an in-keyboard pointing device 20, and the primary monitor 11 are connected to the input and output interface 16. In addition, a mouse 18 and the external monitor 21 as the secondary monitor are connected to the input and output interface 16. The in-keyboard pointing device 20 and the mouse 18 instruct coordinates of a mouse pointer to be displayed on screens of the primary monitor 11 and the secondary monitor 21. The in-keyboard pointing device 20 is a built-in pointing device while the mouse 18 is an external pointing device. In the following, the embodiment will be described on the assumption that the pointing device is the mouse 18.

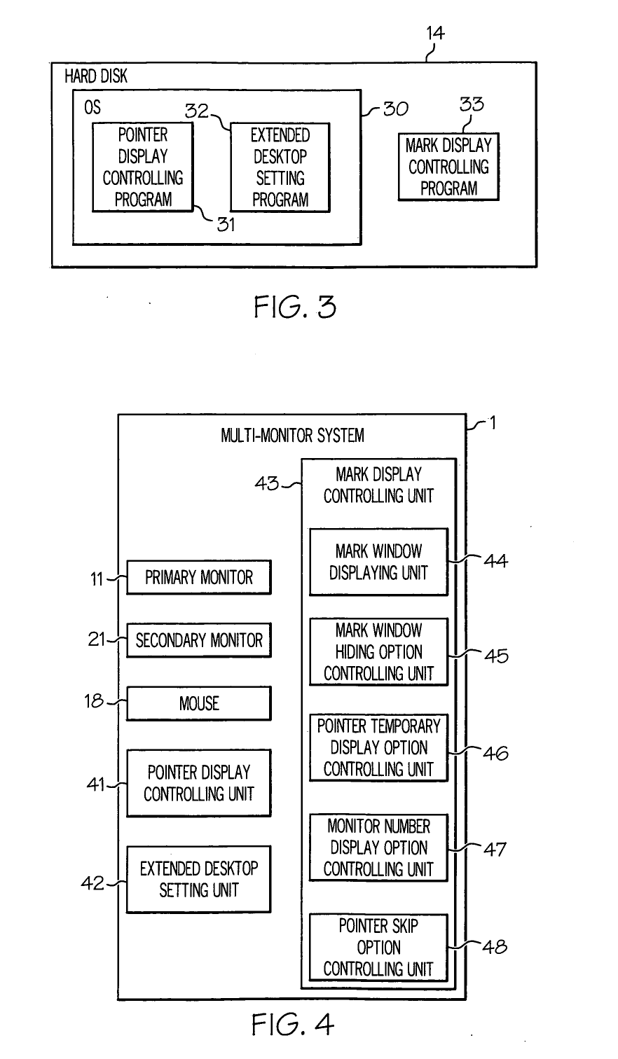

Referring to FIG. 3, a general-purpose operating system 30 is stored in the hard disk 14. The operating system 30 includes a pointer display controlling program 31 and an extended desktop setting program 32. The pointer display controlling program 31 displays the mouse pointer at the coordinates instructed by the mouse 18. The extended desktop setting program 32 has a multi-monitor function for virtually connecting a periphery of the screen of the primary monitor 11 to a periphery of the screen of the secondary monitor 21 in a predetermined position and rendering the mouse pointer bi-directionally movable between the screens of the primary monitor 11 and the secondary monitor 21. The hard disk 14 further stores a mark display controlling program 33 for displaying a mark window for identifying the predetermined position on the screen of the primary monitor 11 and/or the screen of the secondary monitor 21.

Here, the mark display controlling program 33 may be provided in the form of a preinstalled program in the hard disk 14, in the form of a program recorded in a computer-readable recording medium such as a CD-ROM 19, or through an electric communication line such as the Internet.

Referring to FIG. 4, the multi-monitor system 1 causes the computer 10 to execute the pointer display controlling program 31, the extended desktop setting program 32, and the mark display controlling program 33, thereby causing the computer 10 to function as a pointer display controlling unit 41, an extended desktop setting unit 42, and a mark display controlling unit 43, respectively.

The pointer display controlling unit 41 displays the mouse pointer at the coordinates instructed by the mouse 18. The extended desktop setting unit 42 virtually connects the periphery of the screen of the primary monitor 11 to the periphery of the screen of the secondary monitor in the predetermined position, and thereby renders the mouse pointer bi-directionally movable between the screens of the primary monitor 11 and the secondary monitor 21.

The mark display controlling unit 43 includes a mark window displaying unit 44, a mark window hiding option controlling unit 45, a pointer temporary stop option controlling unit 46, a monitor number display option controlling unit 47, and a pointer skip option controlling unit 48.

The mark window displaying unit 44 displays the mark window for identifying the predetermined position on the screens of the primary monitor 11 and the secondary monitor 21 adjacently to the predetermined position. The mark window hiding option controlling unit 45 stops display of the mark window when the mouse pointer is moved onto the mark window or in the vicinity thereof. The pointer temporary stop option controlling unit 46 stops the mouse pointer when the mouse pointer reaches the predetermined position. Moreover, when the mouse 18 instructs the coordinates for moving the mouse pointer from one of the screens of the primary monitor 11 and the secondary monitor 21 to the other screen after the mouse pointer is stopped, the pointer temporary stop option controlling unit 46 releases the stop of the mouse pointer and permits movement of the mouse pointer to the other screen. The monitor number display option controlling unit 47 displays information on the screen of one of the monitors for identifying the other monitor when the mouse pointer is moved from one of the screens of the primary monitor 11 and the secondary monitor 21 to the other screen. In an extended desktop environment where one edge of the screen of the primary monitor 11 is virtually connected to a corresponding edge of the screen of the secondary monitor at a predetermined section as the predetermined position, the pointer skip option controlling unit 48 stops the mouse pointer when the mouse pointer reaches a section on the edge other than the predetermined section. Moreover, when the mouse 18 instructs the coordinates for moving the mouse pointer from one of the screens of the primary monitor 11 and the secondary monitor 21 to the outside after the mouse pointer is stopped, the pointer skip option controlling unit 48 allows the mouse pointer to skip to one of both ends of the predetermined section closer to a position of the mouse pointer, releases the stop of the mouse pointer, and permits movement of the mouse pointer to the other screen.

2. Operation

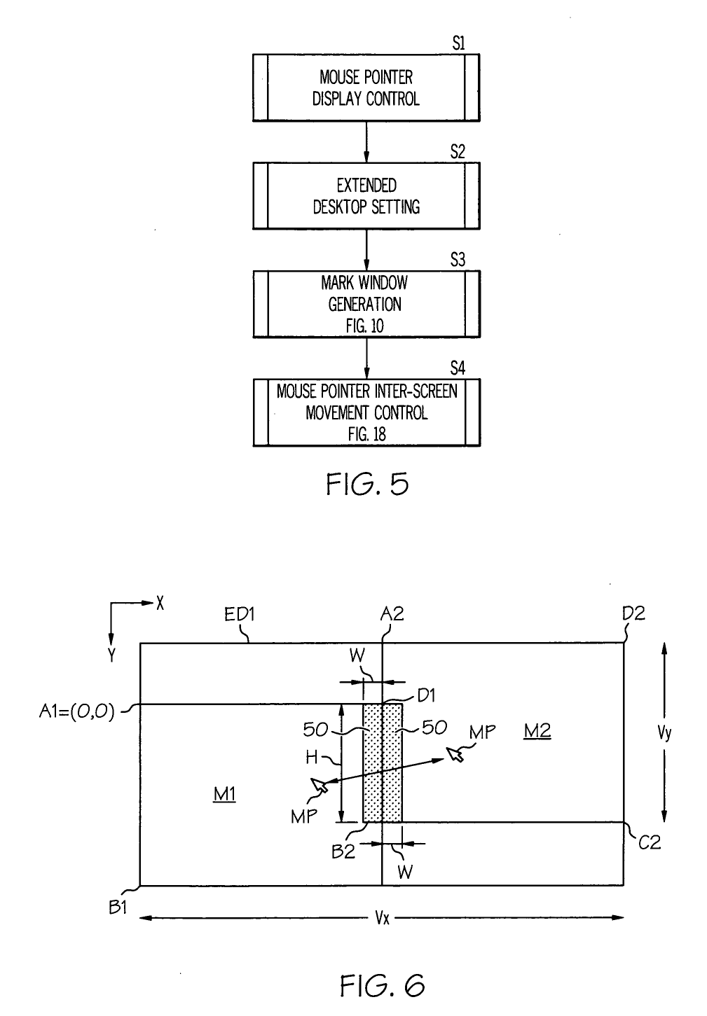

Next, an operation of the multi-monitor system 1 will be described with reference to FIG. 5.

2.1 Pointer Display Control

This system displays the mouse pointer at the coordinates on the screens of the primary monitor 11 and the secondary monitor 21 as instructed by the mouse 18 by causing the computer 10 to execute the pointer display controlling program 31 (S1). When a user moves the mouse 18 in a desired direction, the mouse pointer is moved on the screens in response thereto.

2.2 Extended Desktop Setting

Next, this system 1 performs multi-monitor configuration setting by causing the computer 10 to execute the extended desktop setting program 32 (S2).

As shown in FIG. 6, for example, the extended desktop setting program 32 virtually connects a right edge C1-D1 of a screen M1 of the primary monitor 11 to a left edge A2-B2 of a screen M2 of the secondary monitor 21. In this case, an extended desktop ED1 is obtained when the screen M1 of the primary monitor 11 shifts downward and the screen M2 of the secondary monitor 21 shifts upward. Here, the right edge C1-D1 of the screen M1 of the primary monitor 11 is virtually connected to the left edge A2-B2 of the screen M2 of the secondary monitor 21 at a predetermined section B2-D1 as the predetermined position.

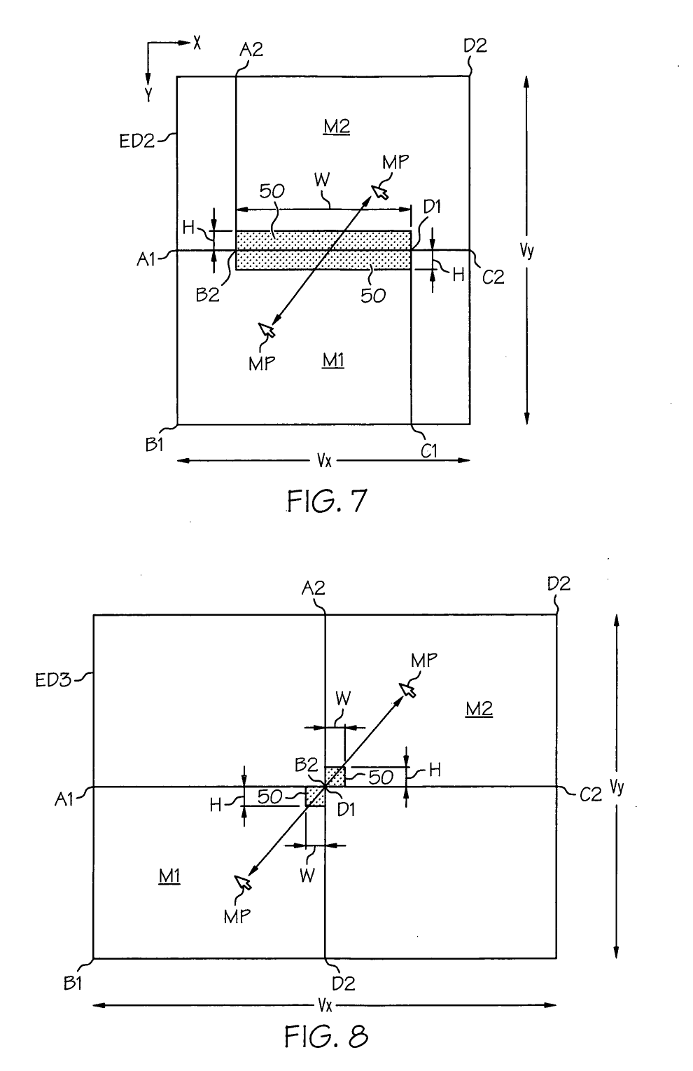

Meanwhile, as shown in FIG. 7, the extended desktop setting program 32 virtually connects an upper edge A1-D1 of the screen M1 of the primary monitor 11 to a lower edge B2-C2 of the screen M2 of the secondary monitor 21. In this case, an extended desktop ED2 is obtained when the screen M1 of the primary monitor 11 shifts to the left and the screen M2 of the secondary monitor 21 shifts to the right. Here, the upper edge A1-D1 of the screen M1 of the primary monitor 11 is virtually connected to the lower edge B2-C2 of the screen M2 of the secondary monitor 21 at the predetermined section B2-D1 as the predetermined position.

Meanwhile, as shown in FIG. 8, the extended desktop setting program 32 virtually connects an upper right vertex D1 of the screen M1 of the primary monitor 11 to a lower left vertex B2 of the screen M2 of the secondary monitor 21. In this way, an extended desktop ED3 is obtained.

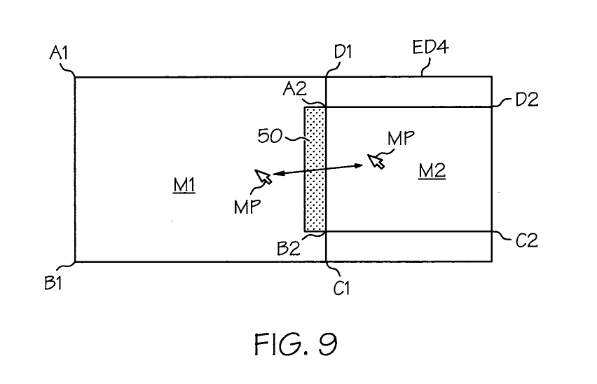

Meanwhile, as shown in FIG. 9, when a resolution of the primary monitor 11 is greater than a resolution of the secondary monitor 21, the extended desktop setting program 32 virtually connects the right edge C1-D1 of the screen M1 of the primary monitor 11 to the left edge A2-B2 of the screen M2 of the secondary monitor 21. In this way, an extended desktop ED4 is obtained. Here, the right edge C1-D1 of the screen M1 of the primary monitor 11 is virtually connected to the left edge A2-B2 of the screen M2 of the secondary monitor 21 with the entire left edge A2-B2 of the screen M2 as the predetermined section.

Moreover, as shown in FIG. 6 to FIG. 9, the extended desktop setting program 32 renders a mouse pointer MP bi-directionally movable between the screen M1 of the primary monitor 11 and the screen M2 of the secondary monitor 21. For example, as shown in FIG. 6, when the screen M1 of the primary monitor 11 is connected to the screen M2 of the secondary monitor 21 at the predetermined section B2-D1, the mouse pointer MP is movable in the predetermined section B2-D1. Meanwhile, as shown in FIG. 7, when the screen M1 of the primary monitor 11 is connected to the screen M2 of the secondary monitor 21 at the predetermined section B2-D1, the mouse pointer MP is movable in the predetermined section B2-D1. Meanwhile, as shown in FIG. 8, when the screen M1 of the primary monitor 11 is connected to the screen M2 of the secondary monitor 21 at the predetermined vertex D1 (B2), the mouse pointer MP is movable at the predetermined vertex D1 (B2) and in the vicinity thereof. Meanwhile, as shown in FIG. 9, when the screen M1 of the primary monitor 11 is connected to the screen M2 of the secondary monitor 21 at the predetermined section A2-B2, the mouse pointer MP is movable in the predetermined section A2-B2.

2.3 Generating Mark Window

Referring to FIG. 5 again, this system 1 generates a mark window 50 and displays the mark window 50 in the foreground on the screen M1 of the primary monitor 11 and/or the screen M2 of the secondary monitor 21 by causing the computer 10 to execute the mark display controlling program 33 (S3).

For example, as shown in FIG. 6, when the screen M1 of the primary monitor 11 is connected to the screen M2 of the secondary monitor 21 at the predetermined section B2-D1, a mark window 50 is displayed on the screen M1 of the primary monitor M1 adjacently to the predetermined section B2-D1 and another mark window 50 is displayed on the screen M2 of the secondary monitor M2 adjacently to the predetermined section B2-D1 so that the predetermined section B2-D1 where the mouse pointer MP is bi-directionally movable between the both screens M1 and M2 can be accurately and promptly grasped.

Meanwhile, as shown in FIG. 7, when the screen M1 of the primary monitor 11 is connected to the screen M2 of the secondary monitor 21 at the predetermined section B2-D1, a mark window 50 is displayed on the screen M1 of the primary monitor M1 adjacently to the predetermined section B2-D1 and another mark window 50 is displayed on the screen M2 of the secondary monitor M2 adjacently to the predetermined section B2-D1 so that the predetermined section B2-D1 where the mouse pointer MP is bi-directionally movable between the both screens M1 and M2 can be accurately and promptly grasped.

Meanwhile, as shown in FIG. 8, when the screen M1 of the primary monitor 11 is connected to the screen M2 of the secondary monitor 21 at the predetermined vertex D1 (B2), a mark window 50 is displayed on the screen M1 of the primary monitor M1 adjacently to the predetermined vertex D1 and another mark window 50 is displayed on the screen M2 of the secondary monitor M2 adjacently to the predetermined vertex B2 so that the predetermined vertex D1 (B2) and the vicinity thereof where the mouse pointer MP is bi-directionally movable between the both screens M1 and M2 can be accurately and promptly grasped.

Meanwhile, as shown in FIG. 9, when the screen M1 of the primary monitor 11 is connected to the screen M2 of the secondary monitor 21 at the predetermined section A2-B2, a mark window 50 is displayed on the screen M1 of the primary monitor M1 adjacently to the predetermined section A2-B2 so that the predetermined section A2-B2 where the mouse pointer MP is bi-directionally movable between the both screens M1 and M2 can be accurately and promptly grasped. However, it is not always necessary to display another mark window on the screen M2 of the secondary monitor M2, because the mouse pointer MP is movable on the entire left edge A2-B2 of the screen M2 of the secondary monitor 21.

By displaying the mark windows 50 as described above, the user can accurately and promptly grasp as to in which position the screen M1 of the primary monitor 11 is connected to the screen M2 of the secondary monitor 21. As a result, the user can move the mouse pointer MP freely between the both screens M1 and M2.

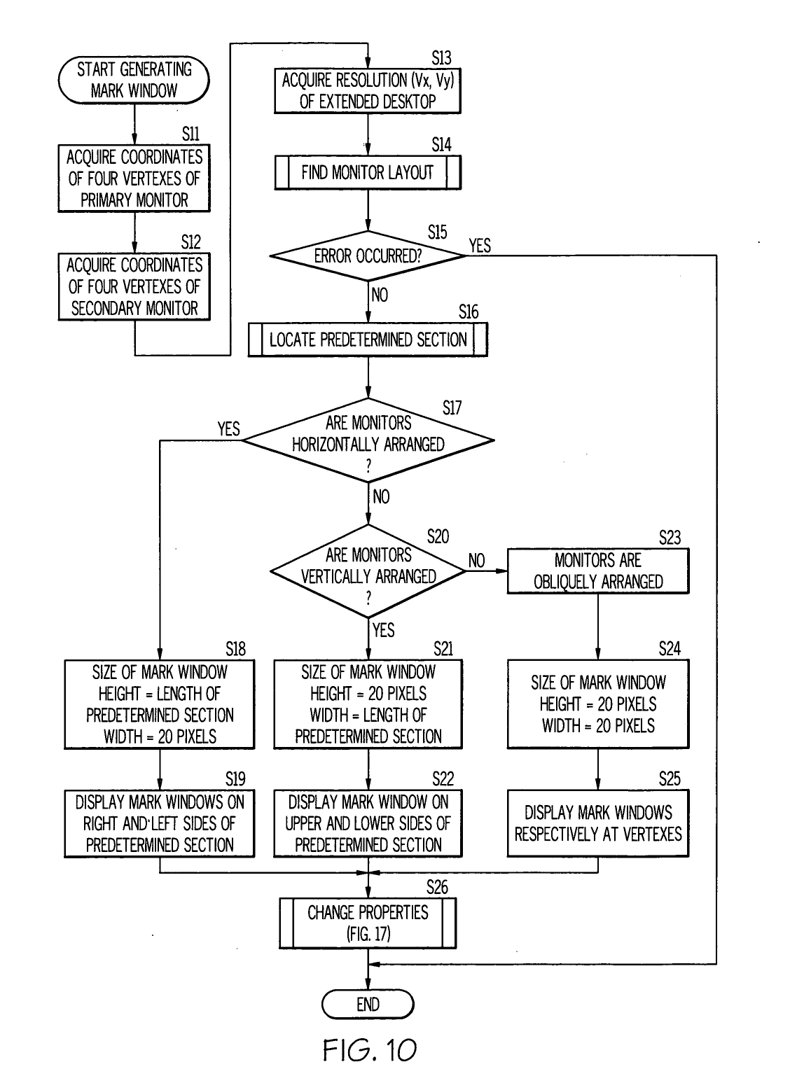

Now, details of mark window generation processing will be described with reference to FIG. 10.

The mark display controlling program 33 acquires coordinates of four vertexes on the screen M1 of the primary monitor 11 out of the information set up by the extended desktop setting program 32 (S11). To be more precise, the mark display controlling program 33 acquires coordinates A1 (A1x, A1y), coordinates B1 (B1x, B1y), coordinates C1 (C1x, C1y), and coordinates D1 (D1x, D1y) as shown in FIG. 6 to FIG. 9.

Moreover, the mark display controlling program 33 acquires coordinates of four vertexes on the screen M2 of the secondary monitor 21 out of the information set up by the extended desktop setting program 32 (S12). To be more precise, the mark display controlling program 33 acquires coordinates A2 (A2x, A2y), coordinates B2 (B2x, B2y), coordinates C2 (C2x, C2y), and coordinates D2 (D2x, D2y) as shown in FIG. 6 to FIG. 9.

Moreover, the mark display controlling program 33 acquires the resolution (Vx, Vy) of any of the extended desktops ED1 to ED4 out of the information set up by the extended desktop setting program 32 (S13).

Thereafter, the mark display controlling program 33 finds a virtual layout of the screens M1 and M2 of the primary monitor 11 and the secondary monitor 21 (S14). The details are as follows.

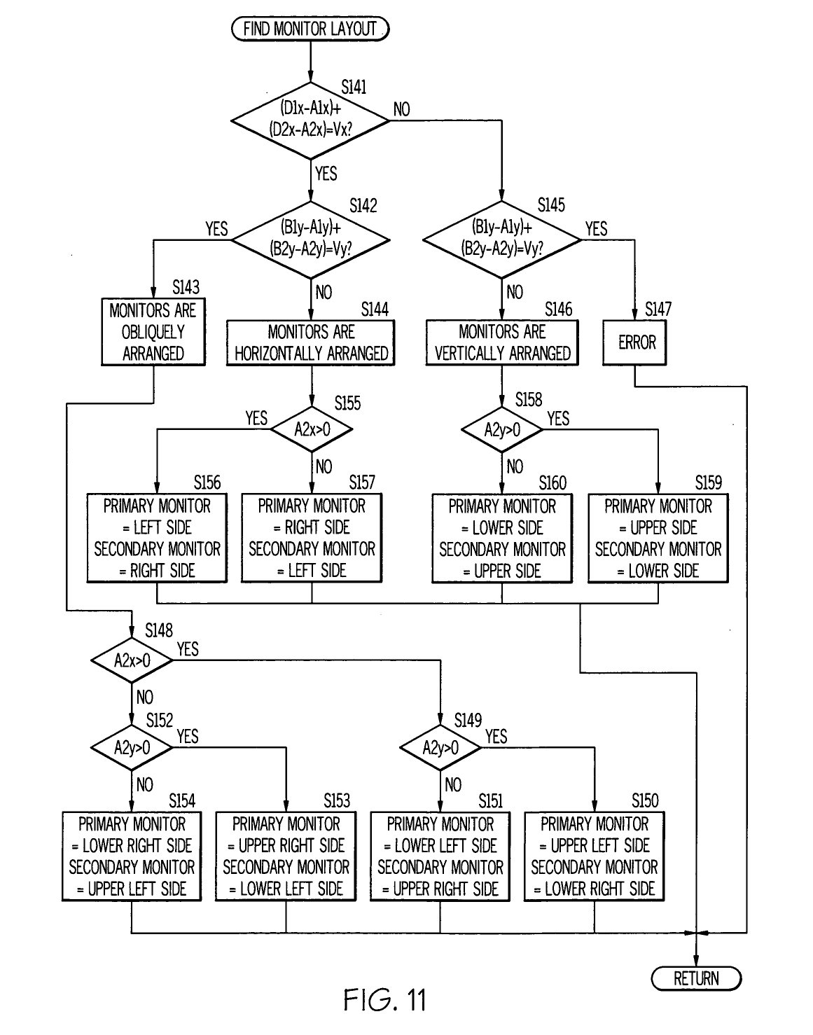

Referring to FIG. 11, the mark display controlling program 33 judges whether or not the following formula (1) holds true (S141).
(D1x−A1x)+(D2x−A2x)=Vx (1)

When the formula (1) holds true, the mark display controlling program 33 judges whether or not the following formula (2) holds true (S142).
(B1y−A1y)+(B2y−A2y)=Vy (2)

When the formula (2) also holds true, the mark display controlling program 33 judges that the screen M1 of the primary monitor 11 and the screen M2 of the secondary monitor 21 are virtually obliquely arranged (S143). By contrast, when the formula (2) does not hold true, the mark display controlling program 33 judges that the screen M1 of the primary monitor 11 and the screen M2 of the secondary monitor 21 are virtually horizontally arranged (S144).

Even when the formula (1) does not hold true, the mark display controlling program 33 judges whether or not the above-mentioned formula (2) holds true (S145).

When the formula (2) holds true in this case, the mark display controlling program 33 judges that the screen M1 of the primary monitor 11 and the screen M2 of the secondary monitor 21 are virtually vertically arranged (S146). By contrast, when the formula (2) does not hold true either, the mark display controlling program 33 issues an error (S147). When the formula (1) does not hold true, the screen M1 of the primary monitor 11 and the screen M2 of the secondary monitor 21 are normally supposed to be virtually vertically arranged. Accordingly, the step S145 is carried out just to be sure, and may therefore be omitted.

In this way, the mark display controlling program 33 can find the layout as to whether the screen M1 of the primary monitor 11 and the screen M2 of the secondary monitor 21 are arranged obliquely, horizontally or vertically.

Next, when the screen M1 of the primary monitor 11 and the screen M2 of the secondary monitor 21 are obliquely arranged (S143), the mark display controlling program 33 judges whether or not A2x>0 holds true; in other words, whether or not the screen M2 of the secondary monitor 21 is located on the right side of the screen M1 of the primary monitor 11 (S148). When A2x>0 holds true, the mark display controlling program 33 judges whether or not A2y>0 holds true; in other words, whether or not the screen M2 of the secondary monitor 21 is located on the lower side of the screen M1 of the primary monitor 11 (S149). When A2y>0 holds true, the mark display controlling program 33 judges that the screen M1 of the primary monitor 11 is located on the upper left side while the screen M2 of the secondary monitor 21 is located on the lower right side (S150). When A2y>0 does not hold true, the mark display controlling program 33 judges that the screen M1 of the primary monitor 11 is located on the lower left side while the screen M2 of the secondary monitor 21 is located on the upper right side (S151).

Meanwhile, even when A2x>0 does not hold true, the mark display controlling program 33 judges whether or not A2y>0 holds true; in other words, whether or not the screen M2 of the secondary monitor 21 is located on the lower side of the screen M1 of the primary monitor 11 (S152). When A2y>0 holds true, the mark display controlling program 33 judges that the screen M1 of the primary monitor 11 is located on the upper right side while the screen M2 of the secondary monitor 21 is located on the lower left side (S153). When A2y>0 does not hold true, the mark display controlling program 33 judges that the screen M1 of the primary monitor 11 is located on the lower right side while the screen M2 of the secondary monitor 21 is located on the upper left side (S154).

Meanwhile, when the screen M1 of the primary monitor 11 and the screen M2 of the secondary monitor 21 are horizontally arranged (S144), the mark display controlling program 33 judges whether or not A2x>0 holds true (S155). When A2x>0 holds true, the mark display controlling program 33 judges that the screen M1 of the primary monitor 11 is located on the left side while the screen M2 of the secondary monitor 21 is located on the right side (S156). When A2x>0 does not hold true, the mark display controlling program 33 judges that the screen M1 of the primary monitor 11 is located on the right side while the screen M2 of the secondary monitor 21 is located on the left side (S157).

Further, when the screen M1 of the primary monitor 11 and the screen M2 of the secondary monitor 21 are vertically arranged (S146), the mark display controlling program 33 judges whether or not A2y>0 holds true (S158). When A2y>0 holds true, the mark display controlling program 33 judges that the screen M1 of the primary monitor 11 is located on the upper side while the screen M2 of the secondary monitor 21 is located on the lower side (S159). When A2y>0 does not hold true, the mark display controlling program 33 judges that the screen M1 of the primary monitor 11 is located on the lower side while the screen M2 of the secondary monitor 21 is located on the upper side (S160).

In this way, the mark display controlling program 33 can find 8 types of positional relations between the screen M1 of the primary monitor 11 and the screen M2 of the secondary monitor 21. As shown in FIG. 10, when the error occurs in the monitor layout confirmation processing (YES in S15), the mark window generation processing is terminated. By contrast, when no error occurs (NO in S15), the mark display controlling program 33 locates the predetermined section for connecting the both screens M1 and M2 by use of the information set up by the extended desktop setting program 32 (S16). The details are as follows.

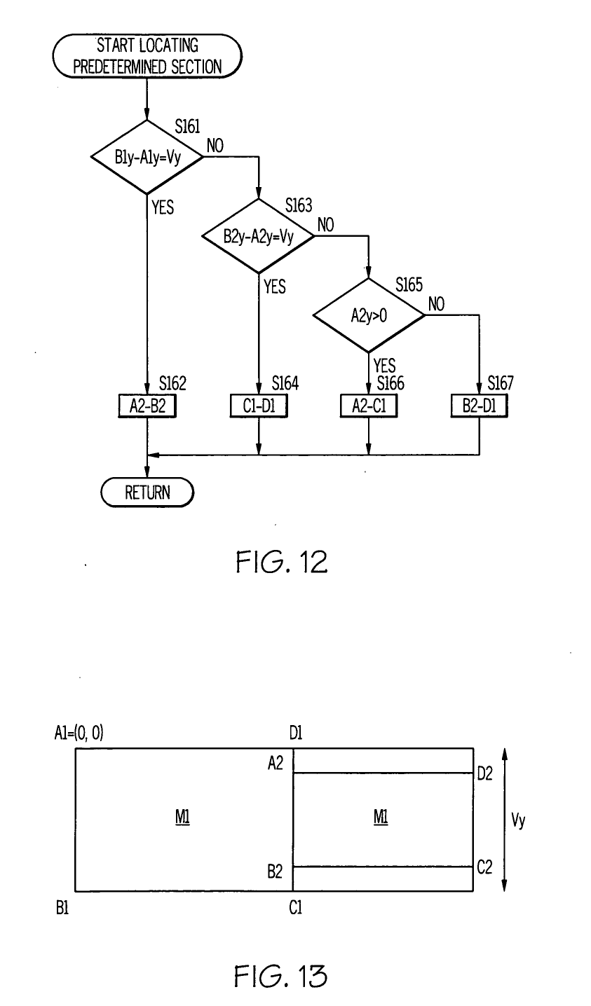

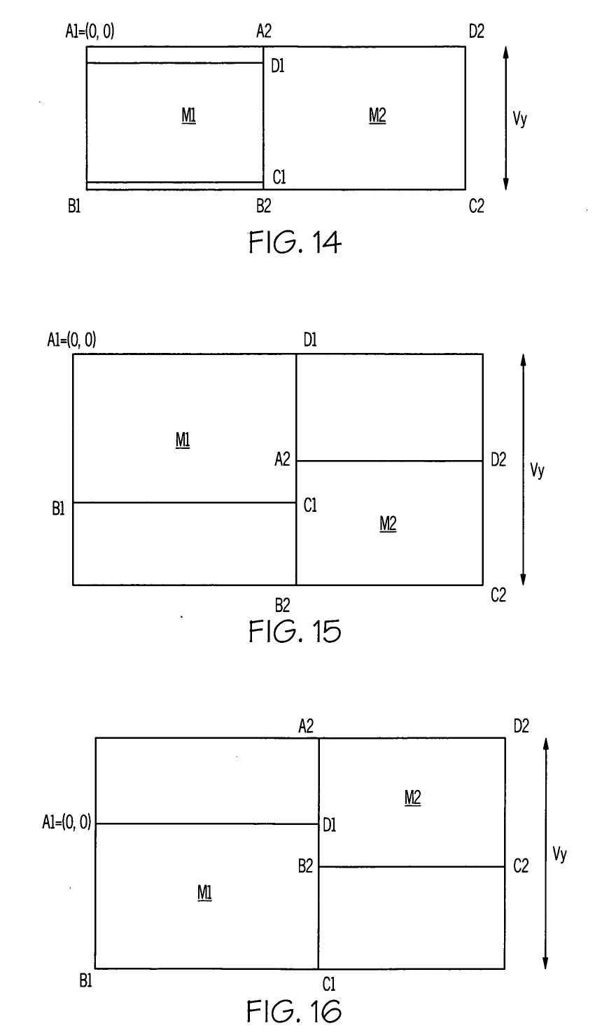

Referring to FIG. 12, the mark display controlling program 33 firstly judges whether or not B1y−A1y=Vy holds true (S161). When B1y−A1y=Vy holds true as shown in FIG. 13, the mark display controlling program 33 locates A2-B2 as the predetermined section (S162). When B1y−A1y=Vy does not hold true, the mark display controlling program 33 judges whether or not B2y−A2y=Vy holds true (S163). When B2y−A2y=Vy holds true as shown in FIG. 14, the mark display controlling program 33 locates C1-D1 as the predetermined section (S164). When B2y−A2y=Vy does not hold true, the mark display controlling program 33 judges whether or not A2y>0 holds true (S165). When A2y>0 holds true as shown in FIG. 15, the mark display controlling program 33 locates A2-C1 as the predetermined section (S166). Meanwhile, when A2y>0 does not hold true as shown in FIG. 16, the mark display controlling program 33 locates B2-D1 as the predetermined section (S167).

Here, the operation has been described on the assumption that the screen M1 of the primary monitor 11 is located on the left side while the screen M2 of the secondary monitor 21 is located on the right side. However, it is also possible to locate the predetermined section in a similar method to the above when the screen M1 of the primary monitor 11 is located on the right side while the screen M2 of the secondary monitor 21 is located on the left side, when the screen M1 of the primary monitor 11 is located on the upper side while the screen M2 of the secondary monitor 21 is located on the lower side, or when the screen M1 of the primary monitor 11 is located on the lower side while the screen M2 of the secondary monitor 21 is located on the upper side.

Referring to FIG. 10 again, after locating the predetermined section, the mark display controlling program 33 judges whether or not the screen M1 of the primary monitor 11 and the screen M2 of the secondary monitor 21 are horizontally arranged (S17). When the screens M1 and M2 of the both monitors are horizontally arranged as shown in FIG. 6, the mark display controlling program 33 determines sizes of the mark windows 50 (S18). To be more precise, a height H is set equal to a length of the predetermined section B2-D1, and a width W is set equal to 20 pixels (S18). Thereafter, the mark display controlling program 33 displays the mark windows 50 on the both screens M1 and M2 of the primary monitor 11 and the secondary monitor 21 (S19). Each of the mark windows 50 is displayed adjacently to the predetermined section B2-D1.

Here, the operation has been described on the assumption that the screen M1 of the primary monitor 11 is located on the left side while the screen M2 of the secondary monitor 21 is located on the right side. However, the operation will be similarly carried out in the oppsite case where the screen M1 of the primary monitor 11 is located on the right side while the screen M2 of the secondary monitor 21 is located on the left side.

When the screens M1 and M2 of the both monitors are not horizontally arranged (NO in S17), the mark display controlling program 33 judges whether or not the screen M1 of the primary monitor 11 and the screen M2 of the secondary monitor 21 are vertically arranged (S20). When the screens M1 and M2 of the both monitors are vertically arranged as shown in FIG. 7, the mark display controlling program 33 determines the sizes of the mark windows 50 (S21). To be more precise, the height H is set equal to 20 pixels, and the width W is set equal to the length of the predetermined section B2-D1 (S21). Thereafter, the mark display controlling program 33 displays the mark windows 50 on the both screens M1 and M2 of the primary monitor 11 and the secondary monitor 21 (S22). Each of the mark windows 50 is displayed adjacently to the predetermined section B2-D1.

Here, the operation has been described on the assumption that the screen M1 of the primary monitor 11 is located on the lower side while the screen M2 of the secondary monitor 21 is located on the upper side. However, the operation will be similarly carried out in the opposite case where the screen M1 of the primary monitor 11 is located on the upper side while the screen M2 of the secondary monitor 21 is located on the lower side.

When the screens M1 and M2 of the both monitors are not vertically arranged (NO in S20), the mark display controlling program 33 judges that the screen M1 of the primary monitor 11 and the screen M2 of the secondary monitor 21 are obliquely arranged as shown in FIG. 8 (S23), and determines the sizes of the mark windows 50 (S24). To be more precise, the height H and the width H are set equal to 20 pixels, respectively (S24). Thereafter, the mark display controlling program 33 displays the mark windows 50 on the both screens M1 and M2 of the primary monitor 11 and the secondary monitor 21 (S25). Each of the mark windows 50 is displayed adjacently to the predetermined vertexes B2 and D1.

Here, the operation has been described on the assumption that the screen M1 of the primary monitor 11 and the screen M2 of the secondary monitor 21 contacted each other at the vertexes D1 and B2. However, the operation will be similarly carried out in other cases where the screen M1 of the primary monitor 11 and the screen M2 of the secondary monitor 21 contact each other at different vertexes such as the vertexes C1 and A2, the vertexes B1 and D2 or the vertexes A1 and C2.

After the mark windows 50 are generated as described above, this system 1 changes properties of the mark windows 50 by causing the computer 10 to execute the mark display controlling program 33 (S26). The details are as follows.

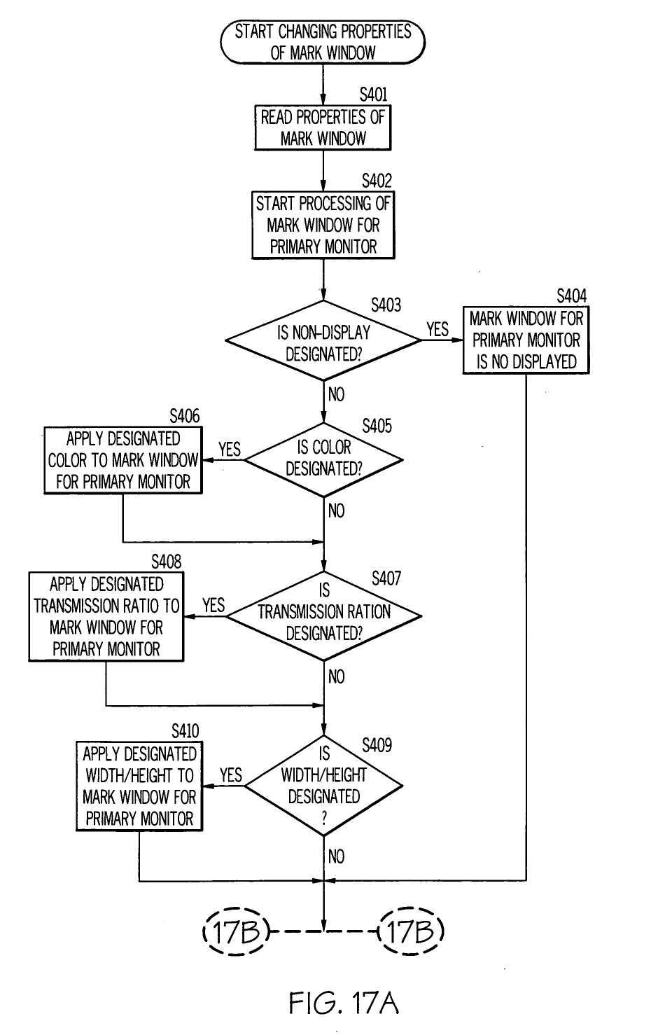

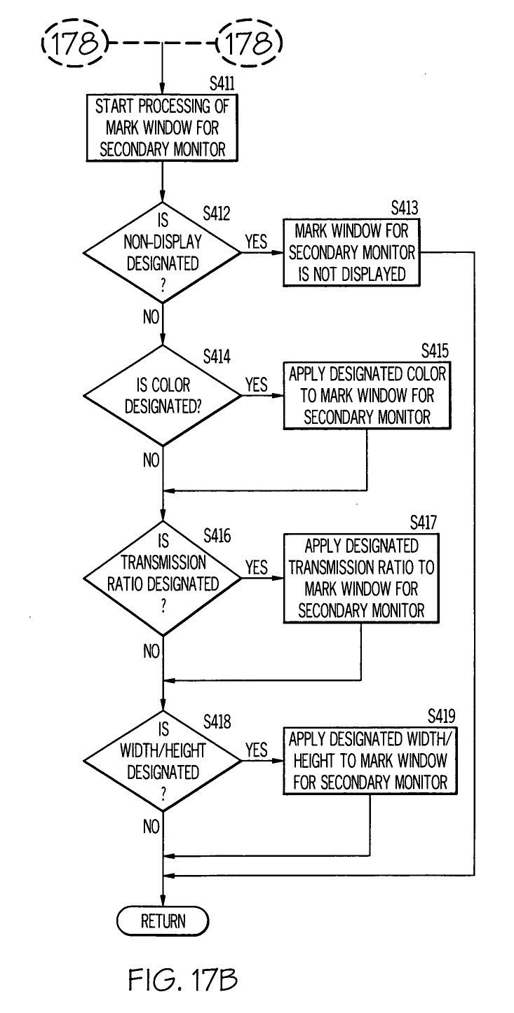

Referring to FIG. 17, the mark display controlling program 33 firstly reads the properties of the mark windows 50 which have been set up already (S401). The properties include display or non-display of the mark windows, colors thereof, transmission ratios thereof, and widths or heights thereof. In a default mode, the properties are preset as shown in the following Table 1. Here, it is possible to provide the contents in Table 1 separately for the primary monitor 11 and for the secondary monitor 21.

TABLE 1
Target window property table

| Properties | Setting |
|---|---|
| Display/Non-display | Display |
| Color | Blue |
| Transmission ratio | 20% |
| Width/Height | 20 pixels |

The mark display controlling program 33 firstly changes the properties of the mark window 50 for the primary monitor 11 as needed (S402).

When the user designates non-display (S403), the mark display controlling program 33 sets the mark window 50 for the primary monitor 11 not to be displayed so that the mark window 50 will be hidden at any time (S404). In this case, the mark window 50 will not be displayed as similar to a conventional case. Accordingly, it is not necessary to set the color, the transmission ratio, and the width or the height of the mark window.

When the user designates the color (S405), the mark display controlling program 33 sets the color of the mark window 50 for the primary monitor 11 to the designated color (S406).

When the user designates the transmission ratio (S407), the mark display controlling program 33 sets the transmission ratio of the mark window 50 for the primary monitor 11 to the designated transmission ratio (S408). When the transmission ratio is set to a high value, objects (such as an icon, a task bar, a tool bar, or other windows) displayed below the mark window 50 become visible.

When the user designates the width and/or the height (S409), the mark display controlling program 33 sets the width W and/or the height H of the mark window 50 for the primary monitor 11 to the designated width and/or height (S410). When the mark window 50 is displayed along the vertical edge of the screen as shown in FIG. 6, the width W will be set up herein. When the mark window 50 is displayed along the horizontal edge of the screen as shown in FIG. 7, the height H will be set up herein. When the mark window 50 is displayed on a corner of the screen as shown in FIG. 8, the width W and the height H will be set up herein.

Next, the mark display controlling program 33 changes the properties of the mark window 50 for the secondary monitor 21 as needed (S411).

When the user designates non-display (S412), the mark display controlling program 33 sets the mark window 50 for the secondary monitor 21 not to be displayed so that the mark window 50 will be hidden at any time (S413).

When the user designates the color (S414), the mark display controlling program 33 sets the color of the mark window 50 for the secondary monitor 21 to the designated color (S415).

When the user designates the transmission ratio (S416), the mark display controlling program 33 sets the transmission ratio of the mark window 50 for the secondary monitor 21 to the designated transmission ratio (S417).

When the user designates the width and/or the height (S418), the mark display controlling program 33 sets the width W and/or the height H of the mark window 50 for the secondary monitor 21 to the designated width and/or height (S419).

2.4 Mouse Pointer Inter-Screen Movement Control

Referring to FIG. 5 again, after changing the properties of the mark windows 50 as described above, this system 1 controls movement of the mouse pointer MP between the screens M1 and M2 by causing the computer 10 to execute the mark display controlling program 33 (S4).

As shown in the following Table 2, options OP1 to OP4 are prepared concerning movement control of the mouse pointer MP. Here, it is possible to provide the contents in Table 2 separately for the primary monitor 11 and for the secondary monitor 21.

TABLE 2
Option setting table

| Option | Effective/Ineffective | Description |
|---|---|---|
| OP1 | Effective | Hide mark window |
| OP2 | Effective | Stop pointer temporarily |
| OP3 | Ineffective | Display monitor number |
| OP4 | Ineffective | Pointer skip |

When the option OP1 is effective, the mark window 50 is hidden by stopping display of the mark window 50 if the mouse pointer MP is moved onto the mark window 50 or in the vicinity thereof.

According to the option OP1, the mark window 50 is hidden when the mouse pointer MP is moved onto the mark window 50 or in the vicinity thereof. Accordingly, it is possible to operate the objects concealed under the mark window 50, and the mark window 50 will not disturb other operations.

When the option OP2 is effective, the option OP2 forcibly stops the mouse pointer MP if the mouse pointer MP reaches the above-described predetermined section, and detects a stop of the mouse 18 after the mouse pointer MP is forcibly stopped. Moreover, when the mouse instructs the coordinates for moving the mouse pointer MP from one of the screens M1 or M2 to the other screen M2 or M1 after the pointer is forcibly stopped, the option OP2 releases the stop of the mouse pointer MP and permits movement of the mouse pointer MP to the other screen M2 or M1.

According to the option OP2, the mouse pointer MP is forcibly stopped when the mouse pointer MP reaches the above-described predetermined section. Subsequently, when the user tries to move the mouse pointer MP from one of the screens M1 or M2 to the other screen M2 or M1 by moving the mouse 18 again after detecting the stop of the mouse 18, the mouse pointer MP is moved to the other screen M2 or M1. Therefore, the user will not move the mouse pointer MP to the other screen M2 or M1 unintentionally.

When the option OP3 is effective, information is displayed for identifying the monitor where the pointer is positioned after inter-screen movement on the screen of the monitor where the pointer was positioned before inter-screen movement M1 or M2 if the mouse pointer MP has been moved from the screen M1 or M2 of one of the monitors to the screen M2 or M1 of the other monitor.

According to the option OP3, the information for identifying the other monitor is displayed on the screen M1 or M2 when the pointer was moved from one of the screens M1 or M2 to the other screen M2 or M1. Therefore, the user can recognize the fact that the mouse pointer MP has been moved to the other screen M2 or M1 from the screen M1 or M2.

When the option OP4 is effective, in the condition where the both screens M1 and M2 are connected to each other at the predetermined section A2-B2 as shown in FIG. 9, the mouse pointer MP is forcibly stopped if the mouse pointer reaches a section A2-D1 or B2-C1 other than the predetermined section A2-B2. Moreover, the option OP3 detects the stop of the mouse 18 after the mouse pointer MP is forcibly stopped. After detecting the stop of the mouse 18, the option OP4 further allows the mouse pointer MP to skip to one of both ends of the predetermined section A2-B2 which is closer to a position of the mouse pointer MP, when the mouse 18 instructs the coordinates for moving the mouse pointer MP from one of the screens M1 to outside. Then, the option OP4 releases the stop of the mouse pointer MP and permits movement of the mouse pointer MP to the other screen M2.

According to the option OP4, when the mouse pointer MP reaches the section A2-D1 or B2-C1 other than the predetermined section A2-B2, the mouse pointer MP is allowed to skip to the end A2 or B2 of the predetermined section A2-B2 which is closer to the potion of the pointer, and is moved to the other screen M2. Therefore, it is possible to move the mouse pointer MP even at the section A2-D1 or B2-C1 other than the predetermined section A2-B2. In addition, the mouse pointer MP is forcibly stopped when the mouse pointer MP reaches the section A2-D1 or B2-C1 other than the predetermined section A2-B2. Thereafter, the mouse pointer MP is moved to the other screen M2 when the user temporarily stops the mouse 18 and then tries to move the mouse pointer MP from one of the screens M1 to the outside by moving the mouse 18 again. Therefore, the user will not move the mouse pointer MP to the other screen M2 unintentionally.

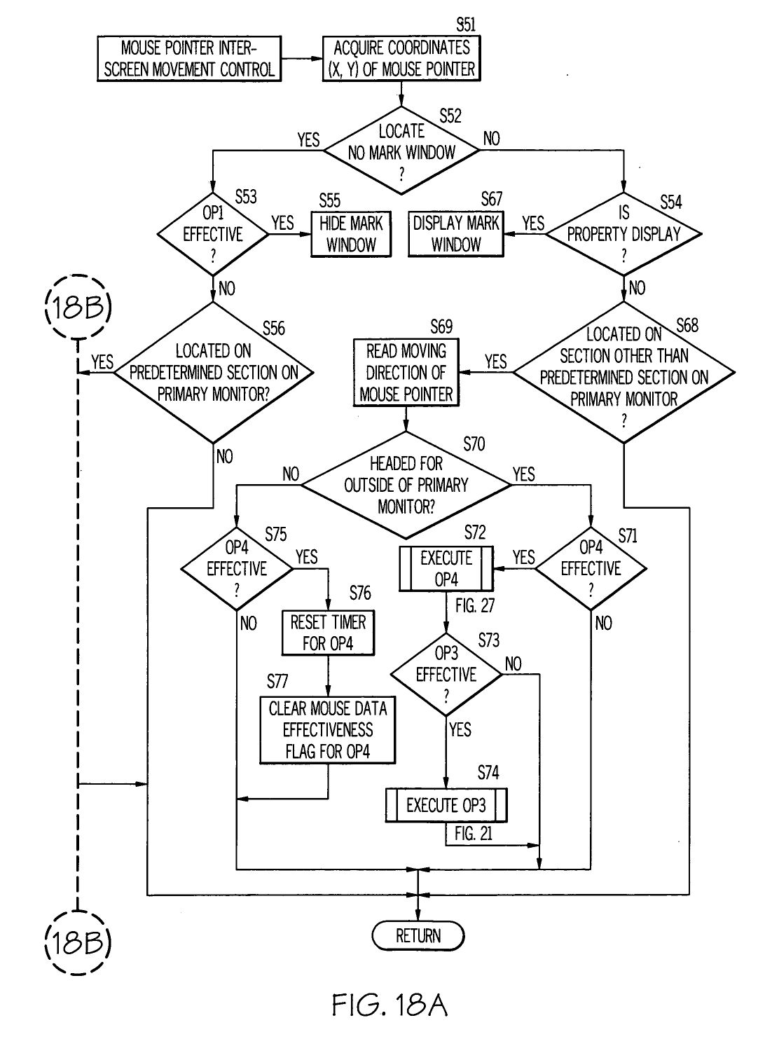

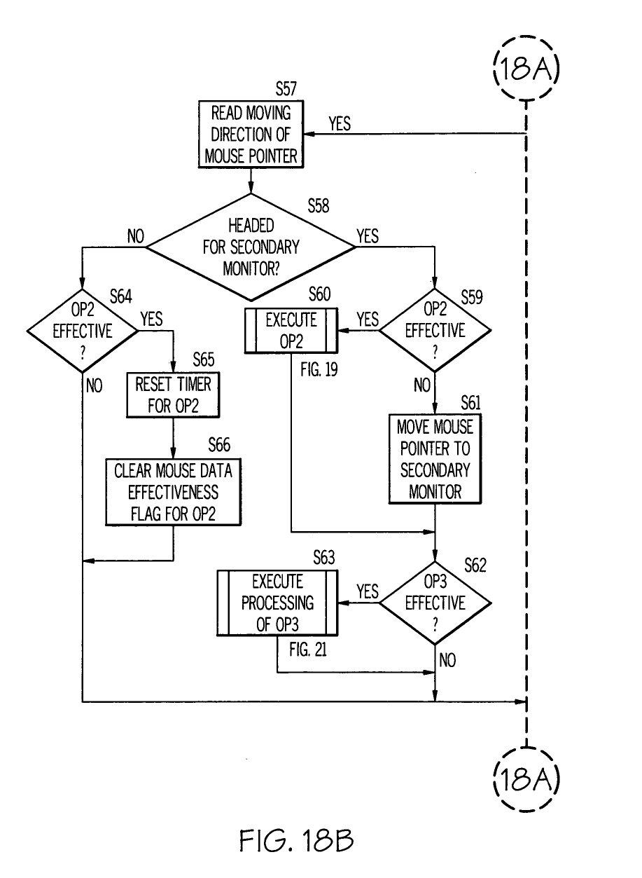

Now, the movement control of the mouse pointer MP will be described in detail with reference to FIG. 18. Here, the operation will be described on the assumption that the mouse pointer MP is located on the screen M1 of the primary monitor 11. However, a similar operation should take place when the mouse pointer MP is located on the screen M2 of the secondary monitor 21.

The mark display controlling program 33 acquires the coordinates of the mouse pointer MP from the pointer display controlling program 31 (S51).

Based on the acquired coordinates, the mark display controlling program 33 judges whether or not the mouse pointer MP is located on the mark window 50 or within a predetermined range from the mark window 50 (hereinafter referred to as “on the mark window or in the vicinity thereof”) (S52). When the mouse pointer MP is located on the mark window 50 or in the vicinity thereof, the operation goes to Step S53. When the mouse pointer MP is not located on the mark window 50 or in the vicinity thereof, the operation goes to Step S54.

Firstly, the operation when the mouse pointer MP is located on the mark window 50 or in the vicinity thereof (YES in S52) will be described. In this case, the mark display controlling program 33 judges whether or not the option OP1 is effective (S53). When the option OP1 is effective, the mark display controlling program 33 stops the display of the mark window 50 and thereby hides the mark window 50 (S55).

Next, the mark display controlling program 33 judges whether or not the mouse pointer MP is located on the predetermined section on the primary monitor 11 (S56). When the mouse pointer MP is located on the predetermined section on the primary monitor 11, the mark display controlling program 33 reads the moving direction of the mouse pointer MP (S57) and then judges whether or not the mouse pointer MP is headed for the screen M2 of the secondary monitor 21.

When the mouse pointer MP is headed for the screen M2 of the secondary monitor 21 (YES in S58), the mark display controlling program 33 judges whether or not the option OP2 is effective (S59). When the option OP2 is effective, the mark display controlling program 33 executes the option OP2 (S60). The details will be described later. When the option OP2 is ineffective, the mark display controlling program 33 permits the pointer display controlling program 31 to move the mouse pointer MP onto the screen M2, and thereby moves the mouse pointer MP onto the screen M2 immediately (S61).

Subsequently, the mark display controlling program 33 judges whether or not the option OP3 is effective (S62). When the option OP3 is effective, the mark display controlling program 33 executes the option OP3 (S63). The details will be described later.

Meanwhile, when the mouse pointer MP is not headed for the secondary monitor 21 (NO in S58), the mark display controlling program 33 judges whether or not the option OP2 is effective (S64). When the option OP2 is effective, the mark display controlling program 33 resets a timer (to be described later in detail) for the option OP2 (S65), and clears a mouse data effectiveness flag (to be described later in detail) for the option OP2 (S66).

Next, the operation when the mouse pointer MP is not located on the mark window 50 or in the vicinity thereof (NO in S52) will be described. In this case, the mark display controlling program 33 judges whether the property of the mark window 50 is set to “display” or “non-display” (S54). When the property is set to “display”, the mark display controlling program 33 displays the mark window 50 instead of hiding (S67).

Next, the mark display controlling program 33 judges whether or not the mouse pointer MP is located on a section other than the predetermined section on the primary monitor 11, which is the section B2-C1 in terms of FIG. 6 and the section A1-B2 in terms of FIG. 7 (S68). When the mouse pointer MP is located on the section other than the predetermined section on the primary monitor 11, the mark display controlling program 33 reads the moving direction of the mouse pointer MP (S69), and judges whether or not the mouse pointer MP is headed to the outside of the screen M1 of the primary monitor 11 (S70).

When the mouse pointer MP is headed for the outside of the screen M1 of the primary monitor 11 (YES in S70), the mark display controlling program 33 judges whether or not the option OP4 is effective (S71). When the option OP4 is effective, the mark display controlling program 33 executes the option OP4 (S72). The details will be described later.

Subsequently, the mark display controlling program 33 judges whether or not the option OP3 is effective (S73). When the option OP3 is effective, the mark display controlling program 33 executes the option OP3 (S74).

Meanwhile, when the mouse pointer MP is not headed for the outside of the screen M1 of the primary monitor 11 (NO in S70), the mark display controlling program 33 judges whether or not the option OP4 is effective (S75). When the option OP4 is effective, the mark display controlling program 33 resets a timer (to be described later in detail) for the option OP4 (S76), and clears a mouse data effectiveness flag (to be described later in detail) for the option OP4 (S77).

2.5.1 Pointer Temporary Stop Option: OP2

This option OP2 forcibly stops the mouse pointer MP on the predetermined section by nullifying coordinate data (hereinafter referred to as “mouse data”) inputted from the mouse 18 even after the mouse pointer MP reaches the predetermined section. Moreover, when movement of the mouse 18 is stopped for a predetermined period of time (such as 500 milliseconds) or longer, the option OP2 moves the mouse pointer MP onto the screen M2 of the secondary monitor 21 by enabling the mouse data. A mouse data effectiveness flag is used for a judgment as to whether the mouse data should be enabled or nullified. The mouse data effectiveness flag is set on to enable the mouse data, and the mouse data effectiveness flag is cleared (reset) to nullify the mouse data. Moreover, a timer is used for measuring stop time of the mouse 18. This timer for the option OP2 is reset every time when the mouse data are nullified, and starts measurement again.

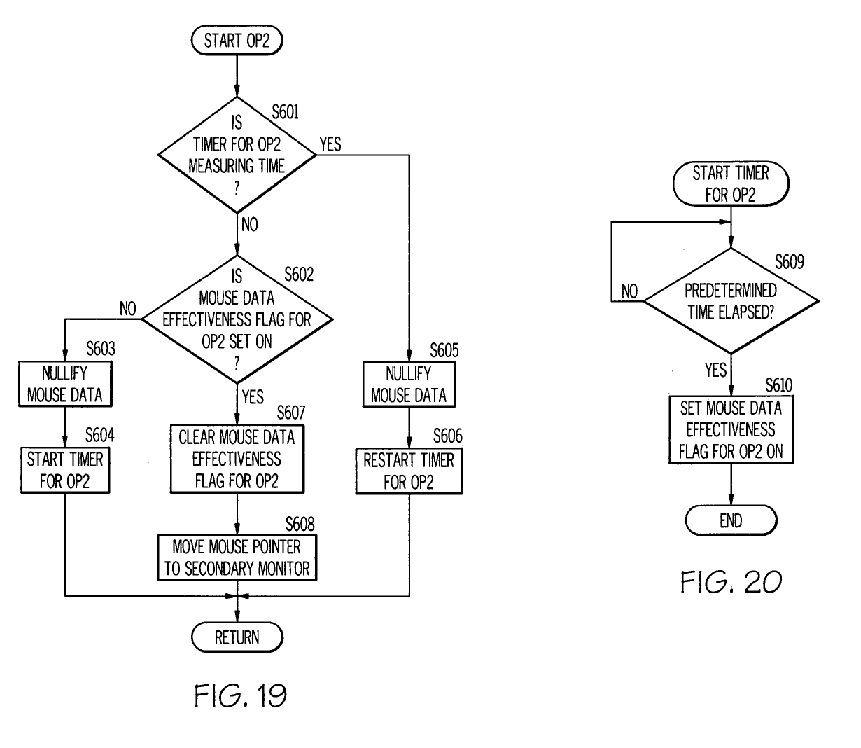

Referring to FIG. 19, the mark display controlling program 33 judges whether or not the timer for the option OP2 is in the course of timekeeping (S601). In the beginning, the timer is not in the course of time keeping. Accordingly, the mark display controlling program 33 judges whether or not the mouse data effectiveness flag is set on (S602). In the beginning, the mouse data effectiveness flag is not set on. Accordingly, the mark display controlling program 33 nullifies the mouse data (S603), and starts the timer for the option OP2 (S604).

The mouse data will be sequentially and continuously generated when the mouse 18 is kept moving even after the mouse pointer MP reaches the predetermined section. Accordingly, referring to FIG. 18, the mark display controlling program 33 executes the option OP2 again (S60).

In this case, referring to FIG. 19 again, the mark display controlling program 33 judges again whether or not the timer for the option OP2 is in the course of timekeeping (S601). In this case, the timer is in the course of time keeping. Accordingly, the mark display controlling program 33 nullifies the mouse data (S605), resets the timer for the option OP2 and starts the timer again (S606).

Therefore, as long as the mouse 18 is kept moving even after the mouse pointer MP reaches the predetermined section, the mark display controlling program 33 repeats execution of the option OP2 (S60). As a result, the timer for the option OP2 repeats very short timekeeping. Since all the mouse data generated sequentially and continuously during this period are nullified, the mouse pointer is stopped on the predetermined section.

While executing the processing shown in FIG. 19, the mark display controlling program 33 also executes processing shown in FIG. 20 in parallel. Referring to FIG. 20, the mark display controlling program 33 judges whether or not the time measured by the timer for the option OP2 reaches the predetermined period of time (S609). As described above, the mouse data will be sequentially and continuously generated when the mouse 18 is kept moving even after the mouse pointer MP reaches the predetermined section. Accordingly, the time measured by the timer for the option OP2 is always shorter than the predetermined period of time (NO in S609). However, if the mouse 18 is temporarily stopped after the mouse pointer reaches the predetermined section and is moved again, the time measured by the timer for the option OP2 exceeds the predetermined period of time (YES in S609). Hence the mark display controlling program 33 sets the mouse data effectiveness flag (S610) on, and stops the timer for the option OP2. That is, the mark display controlling program 33 detects the stop of the mouse 18 at this point.

Referring to FIG. 19 again, when the timer for the option OP2 is not in the course of timekeeping (NO in S601) and the mouse data effectiveness flag is set on (YES in S602), the mark display controlling program 33 clears the mouse data effectiveness flag for the option OP2 (S607), and permits the pointer display controlling program 31 to move the mouse pointer MP onto the screen M2 of the secondary monitor 21 (S608). Hence the pointer display controlling program 31 moves the mouse pointer MP onto the screen M2 of the secondary monitor 21.

2.5.2 Monitor Number Display Option: OP3

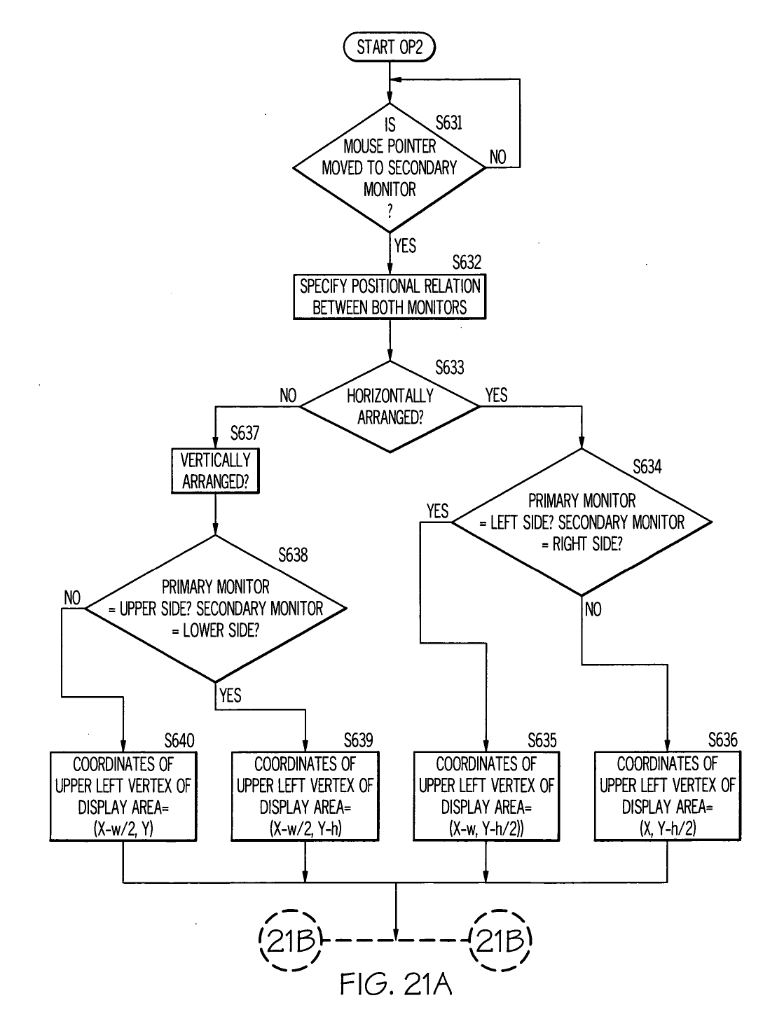

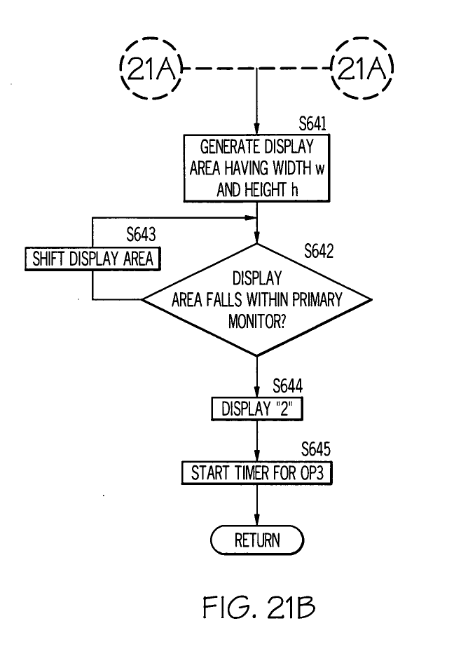

Referring to FIG. 21, when the mouse pointer MP is moved onto the screen M2 of the secondary monitor 21 (YES in S631), the mark display controlling program 33 specifies the positional relation between the screen M1 of the primary monitor 11 and the screen M2 of the secondary monitor 21 (S632).

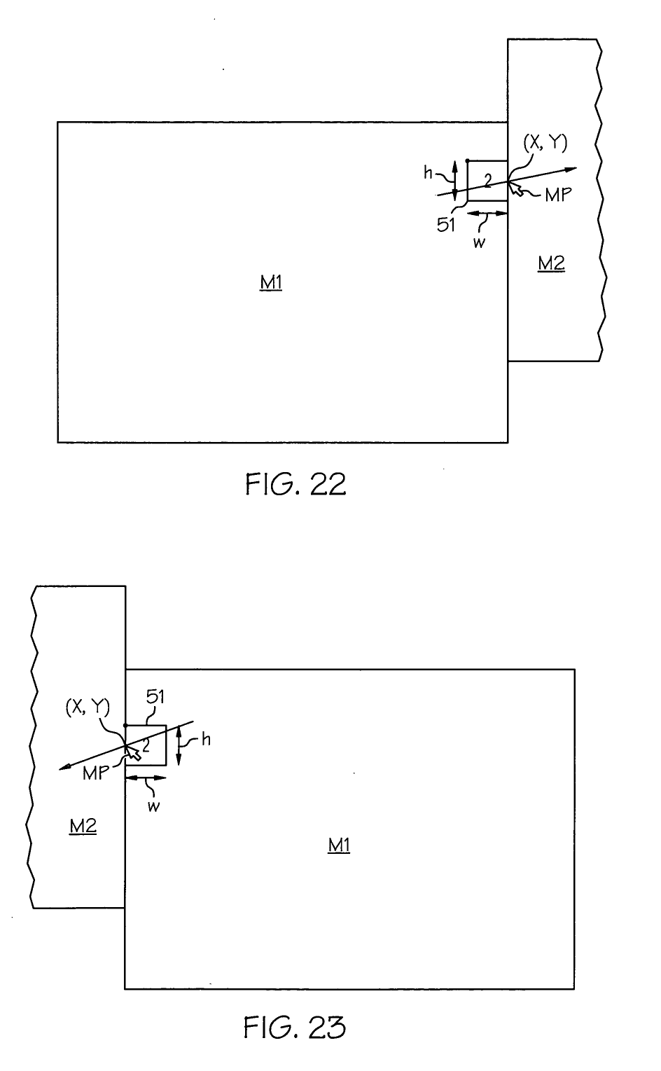

To be more precise, the mark display controlling program 33 judges whether or not the screens M1 and M2 of the both monitors 11 and 21 are horizontally arranged (S633). When the screens M1 and M2 are horizontally arranged (YES in S633), the mark display controlling program 33 judges whether or not the screen M1 of the primary monitor 11 is located on the left side while the screen M2 of the secondary monitor 21 is located on the right side (S634). When the screen M1 is located on the left side while the screen M2 is located on the right side (YES in S634), the mark display controlling program 33 sets the coordinates of an upper left vertex of a display area 51 for displaying a number of the destination monitor (“2” in this case) to (X-w, Y-h/2) as shown in FIG. 22 (S635). By contrast, when the screen M1 is located on the right side while the screen M2 is located on the left side (NO in S634), the mark display controlling program 33 sets the coordinates of the upper left vertex of the display area 51 to (X, Y-h/2) as shown in FIG. 23 (S636).

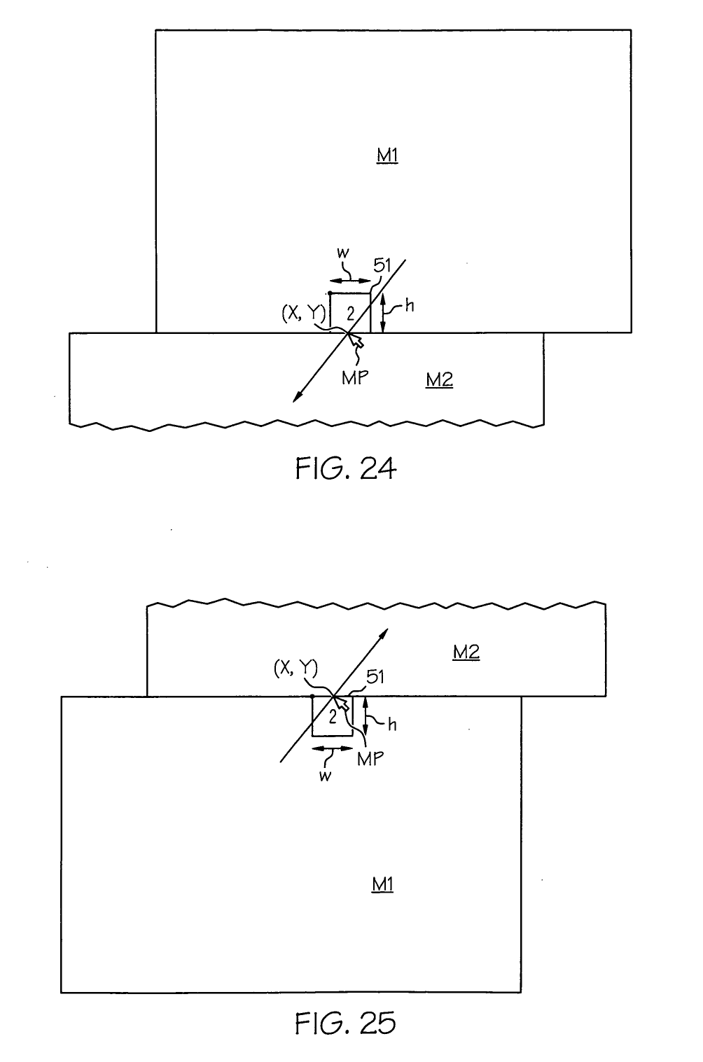

When the screens M1 and M2 are not horizontally arranged (NO in S633), the mark display controlling program 33 judges that the screens M1 and M2 are vertically arranged (S637), and subsequently judges whether or not the screen M1 of the primary monitor 11 is located on the upper side while the screen M2 of the secondary monitor 21 is located on the lower side (S638). When the screen M1 is located on the upper side while the screen M2 is located on the lower side (YES in S638), the mark display controlling program 33 sets the coordinates of the upper left vertex of the display area 51 to (X-w/2, Y-h) as shown in FIG. 24 (S639). By contrast, when the screen M1 is located on the lower side while the screen M2 is located on the upper side (NO in S638), the mark display controlling program 33 sets the coordinates of the upper left vertex of the display area 51 to (X-w/2, Y) as shown in FIG. 25 (S640).

Next, the mark display controlling program 33 generates the display area 51 having the width W and the height H (S641), and judges whether or not the display area 51 falls within the screen M1 of the primary monitor 11 (S642). When the mouse pointer passes the vicinity of the end of the predetermined section, the display area 51 does not fall within the screen M1. In this case, the display area is appropriately shifted so that the display area falls within the screen M1 (S643). When the display area 51 falls within the screen M1 (YES in S642), the mark display controlling program 33 displays “2” for indicating the monitor number of the secondary monitor 21 in the display area 51 (S644). Thereafter, the mark display controlling program 33 starts a timer for the option OP3 (S645).

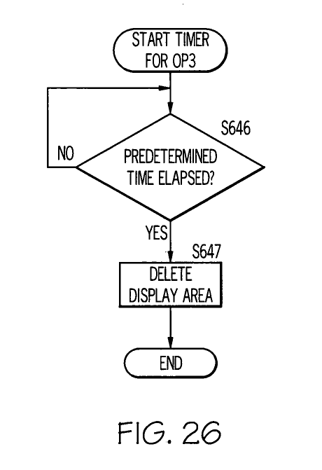

After the timer for the option OP3 is started, referring to FIG. 26, the mark display controlling program 33 judges whether or not time measured by the timer for the option OP3 reaches a predetermined period of time (S646). If the predetermined (such as 3 seconds) time goes by after displaying the number of the destination monitor, it is presumably possible for the user to recognize that the mouse pointer MP is moved onto the screen M2 of the secondary monitor 21. Accordingly, the mark display controlling program 33 judges that the display area 51 has accomplished its objective and therefore deletes the display area 51. In this way, the timer for the option OP3 terminates timekeeping.

2.5.3 Pointer Skip Option: OP4

This option OP4 forcibly stops the mouse pointer MP on the section other than the predetermined section by nullifying the mouse data inputted even after the mouse pointer MP reaches the section other than the predetermined section. The option OP4 is similar to the option OP2, in which a timer for the option OP4 is used instead of the timer for the option OP2 and a mouse data effectiveness flag for the option OP4 is used instead of the mouse data effectiveness flag for the option OP2.

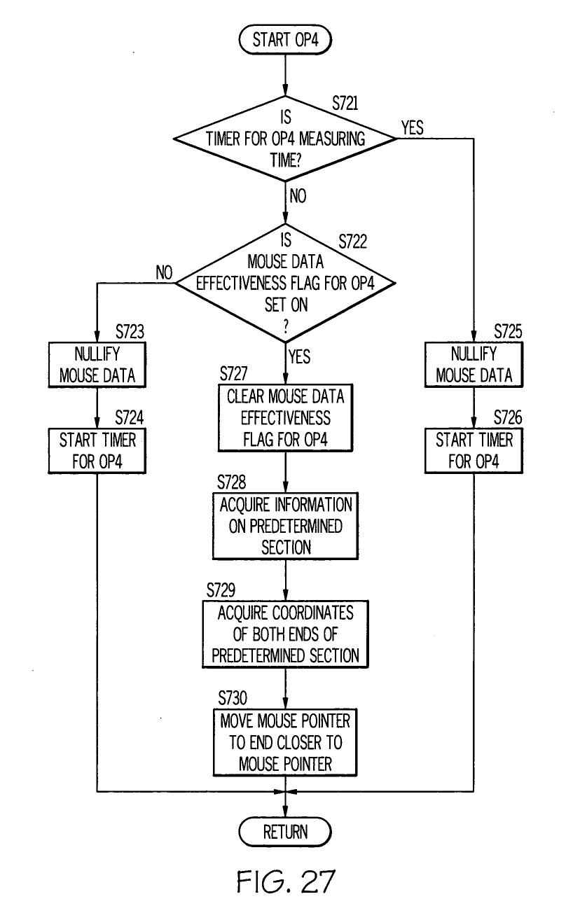

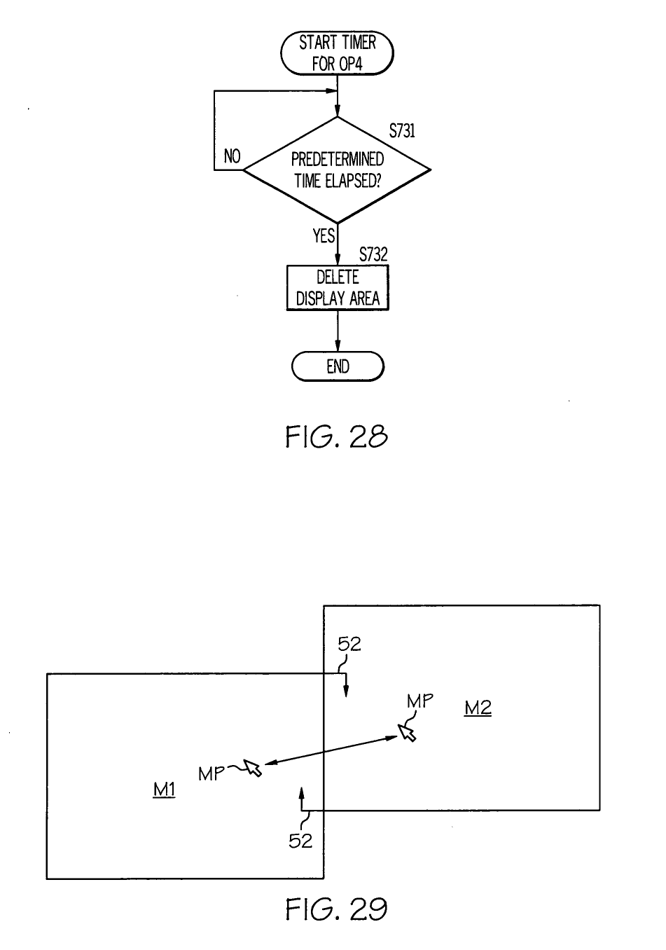

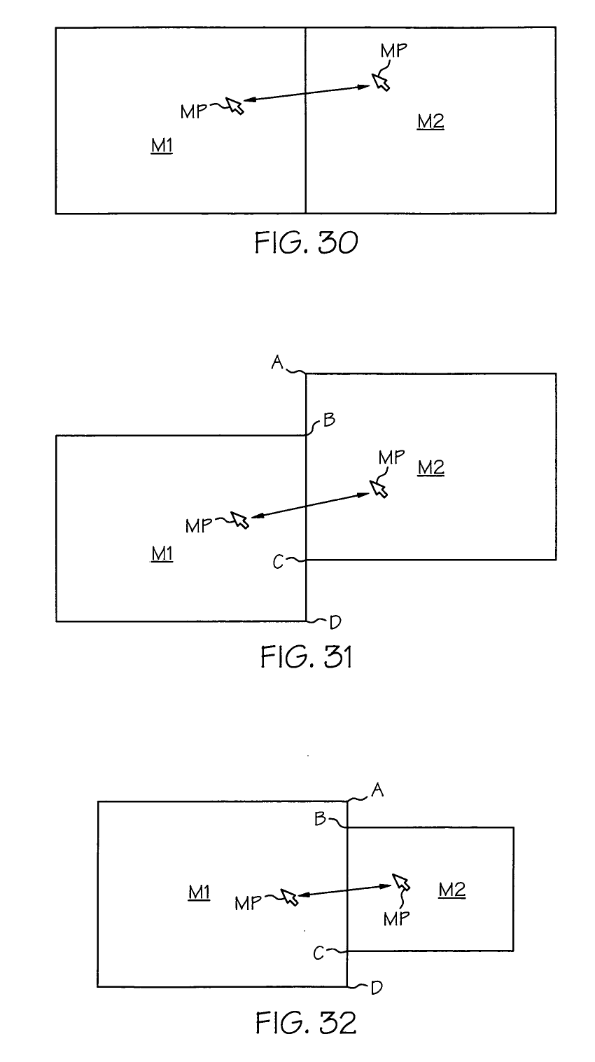

Steps S721 to S727 shown in FIG. 27 and Steps S731 and S732 shown in FIG. 28 are identical to Steps S601 to S607 shown in FIG. 19 and Steps S609 and S610 shown in FIG. 20, respectively. Therefore, the relevant explanation will not be repeated. Here, the mark display controlling program 33 detects the stop of the mouse 18 in Steps S731 and S732.

Referring to FIG. 27, after clearing the mouse data effectiveness flag for the option OP4 (S727), the mark display controlling program 33 acquires information on the predetermined section where the screen M1 of the primary monitor 11 and the screen M2 of the secondary monitor 22 are connected to each other (S728), and also acquires coordinates of both ends thereof (S729). Then, the mark display controlling program 33 changes the coordinates of the mouse pointer to those of the end of the predetermined section closer to the current pointer coordinates, and permits the pointer display controlling program 31 to move the mouse pointer MP onto the screen M2 of the secondary monitor 21 (S730). Hence the pointer display controlling program 31 allows the mouse pointer MP to skip to one of the both ends of the predetermined section closer to the mouse pointer MP, and moves the mouse pointer MP onto the screen M2 of the secondary monitor 21.

As described above, according to the embodiment of the present invention, the mark windows 50 are displayed along the predetermined section on the screens M1 and M2 of the primary monitor 11 and the secondary monitor 21. Therefore, it is possible to easily and promptly identify the position where the mouse pointer MP is bi-directionally movable between the screens M1 and M2. As a result, it is easy to move the mouse pointer MP bi-directionally between the both screens M1 and M2 without losing sight of the mouse pointer MP, for example. In this way, it is possible to enhance operability of the mouse 18.

The pointer temporary stop option OP2 of the above-described embodiment is configured to move the mouse pointer MP to the other screen when the user temporarily stops the mouse 18 when the mouse pointer MP is forcibly stopped on the predetermined section and thereafter the user moves the mouse 18 again. However, instead of detecting the stop of the mouse 18, it is also possible to move the mouse pointer MP to the other screen when the user keeps on moving the mouse pointer MP at least for a predetermined period of time continuously after the mouse pointer MP is stopped. To achieve this, Step S606 shown in FIG. 19 may be omitted, for example. In this case, the timer for the option OP2 keeps on measuring the time that the user spends on continuously moving the mouse 18 even after the mouse pointer MP is stopped. Thereafter, when the measured time reaches the predetermined period of time, the mark display controlling program 33 executes Steps S607 and S608 shown in FIG. 19.

Meanwhile, the pointer skip option OP4 is configured to move the mouse pointer MP to the other screen when the user temporarily stops the mouse 18 after the mouse pointer MP is forcibly stopped on the section other than the predetermined section and when the user moves the mouse 18 again. However, instead of detecting the stop of the mouse 18, it is also possible to move the mouse pointer MP to the other screen when the user keeps on moving the mouse pointer MP at least for a predetermined period of time continuously after the mouse pointer MP is stopped. To achieve this, Step S726 shown in FIG. 27 may be omitted, for example. In this case, the timer for the option OP4 keeps on measuring the time that the user spends on continuously moving the mouse 18 even after the mouse pointer MP is stopped. Thereafter, when the measured time reaches the predetermined period of time, the mark display controlling program 33 executes Steps S727 to S730 shown in FIG. 27.

Meanwhile, the shape of the mark window 50 is not only limited to the above-described rectangular shape, and any shape is usable. Moreover, the mark window 50 does not have to contact the predetermined position, and may be disposed away from the predetermined position with a predetermined interval.

Meanwhile, as shown in FIG. 29, it is possible to display an arrow 52 only on the upper end or the lower end of the predetermined position. Alternatively, it is possible to display arrows on both of the upper end and the lower end of the predetermined position. In short, it is only necessary to display an object or some objects for identifying the predetermined position where the mouse pointer MP is movable.

Furthermore, it is possible to set the property of the mark window 50 to “non-display” and to enable only the monitor display option OP3. In this case, the objects such as the mark windows will not displayed. However, the number of the destination monitor will be displayed when the mouse pointer is moved to the other screen. Accordingly, the user will not lose sight of the mouse pointer MP, and it is possible to enhance operability of the mouse 18.

Although the above-described embodiment used the two monitors 11 and 12, the present invention is also applicable to an extended desktop environment using three or more monitors. Also, the type of the computer is not only limited to the above-described notebook type, but any type such as a desktop type is acceptable. In addition, the secondary monitor and other additional monitors are only required to function as external monitors. Accordingly, it is also possible to use projectors and the like.

Meanwhile, in the above-described embodiments, the mark display controlling program 33 is installed as an additional utility separately from the operating system 30. However, it is also possible to incorporate the mark display controlling program 33 into the operating system 30.

Although the preferred embodiment of the invention has been described above, it is to be understood that the above-described embodiment is only an example for embodying the present invention. Therefore, the present invention will not be limited only to the above-described embodiment, and various modifications of the above-described embodiment are possible without departing from the scope and spirit of the present invention.

A multi-monitor system according to the present invention is applicable to a computer operable in an extended desktop environment.

Also, it should be understood that at least some aspects of the present invention may be alternatively implemented in a computer-readable medium that stores a program product. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A multi-monitor system comprising:
a first monitor and a second monitor;
a pointing device for instructing coordinates of a pointer to be displayed on screens of the first and second monitors;
pointer display controlling means for displaying the pointer at the coordinates instructed by the pointing device;
extended desktop setting means for virtually connecting a periphery of a screen of the first monitor to a periphery of a screen of the second monitor in a predetermined position and rendering the pointer bi-directionally movable between the screens of the first and second monitors; and
means for displaying an object for identifying the predetermined position at least on one screen of the first and second monitors.

2. The multi-monitor system according to claim 1,
wherein the object is a mark window to be displayed adjacently to the predetermined position.

3. The multi-monitor system according to claim 2, further comprising:
means for stopping display of the mark window which is activated in response to the movement of the pointer onto the mark window or in the vicinity thereof.

4. The multi-monitor system according to claim 1, further comprising:
means for forcibly stopping the pointer when the pointer reaches the predetermined position; and
pointer movement permitting means for releasing the stop of the pointer and permitting movement of the pointer to the other screen in response to the instruction by the pointing device of coordinates that moves the pointer from one of the screens of the first and second monitors to the other screen after the pointer is forcibly stopped.

5. The multi-monitor system according to claim 4, further comprising:
means for detecting a stop of the pointing device after the pointer is forcibly stopped,
wherein the pointer movement permitting means releases the stop of the pointer and permits movement of the pointer to the other screen in response to the instruction by the pointing device of the coordinates that movies the pointer from one of the screens of the first and second monitors to the other screen after the pointer is forcibly stopped.

6. The multi-monitor system according to claim 1, further comprising:
means for displaying information on one of the screens for identifying the other screen in response to the movement of the pointer from one of the screens of the first and second monitors to the other screen.

7. The multi-monitor system according to claim 1,
wherein the extended desktop setting means virtually connects one edge of the screen of the first monitor to a corresponding edge of the screen of the second monitor at a predetermined section as the predetermined position, and
the multi-monitor system further comprises:
means for forcibly stopping the pointer in response to the arrival of the pointer to a section on the edge other than the predetermined section; and
pointer movement permitting means for allowing the pointer to skip to one of both ends of the predetermined section closer to a position of the pointer in response to the instruction by the pointing device of the coordinates that moves the pointer from one of the screens of the first and second monitor to the outside, releasing the stop of the pointer, and permitting movement of the pointer to the other screen.

8. The multi-monitor system according to claim 7, further comprising:
means for detecting a stop of the pointing device after the pointer is forcibly stopped,
wherein the pointer movement permitting means, after the stop of the pointing device is detected, allows the pointer to skip to one of both ends of the predetermined section closer to a position of the pointer in response to the instruction by the pointing device of the coordinates that moves the pointer from one of the screens of the first and second monitor to the outside, releases the stop of the pointer, and permits movement of the pointer to the other screen.

9. The multi-monitor system according to claim 1 further comprising:
means for displaying information on one of the screens for identifying the other screen in response to the movement of the pointer from one of the screens of the first and second monitors to the other screen.

10. A multi-monitor method comprising:
a step of inputting coordinates of a pointer to be displayed on screens of a first monitor and a second monitor by use of a pointing device;
a step of displaying the pointer at the coordinates inputted by the pointing device;
a step of virtually connecting a periphery of a screen of the first monitor to a periphery of a screen of the second monitor in a predetermined position and rendering the pointer bi-directionally movable between the screens of the first and second monitors; and
a step of displaying an object for identifying the predetermined position at least on one screen of the first and second monitors.

11. The multi-monitor method according to claim 10 further comprising:
a screen extending step of virtually connecting a periphery of a screen of the first monitor to a periphery of a screen of the second monitor in a predetermined position and rendering the pointer bi-directionally movable between the screens of the first and second monitors; and
a step of displaying information on the screen of one of the monitors for identifying the other monitor in response to the movement of the pointer from one of the screens to the other screen of the first and second monitors.

12. A mark displaying program product stored in a computer-readable medium to be operated in an extended desktop environment where a periphery of a screen of a first monitor is virtually connected to a periphery of a screen of a second monitor in a predetermined position and a pointer displayed in compliance with a pointing device is bi-directionally movable between the screens of the first and second monitors, the mark displaying program product causing a computer to execute the steps of:
locating the predetermined position; and
displaying an object for identifying the specified predetermined position at least on one screen of the first and second monitors.

13. The mark displaying program product stored in a computer-readable medium according to claim 12 to be operated in an extended desktop environment where a periphery of a screen of a first monitor is virtually connected to a periphery of a screen of a second monitor in a predetermined position and a pointer displayed in compliance with a pointing device is bi-directionally movable between the screens of the first and second monitors, the mark displaying program product further causing a computer to execute the steps of:
detecting movement of the pointer from one of the screens of the first and second monitors to the other screen; and
displaying information on the screen of one of the monitors for identifying the other monitor.
